(19) United States
(12) Patent Application Publication
(10) Pub. No.: US 2019/0267692 A1
(43) Pub. Date: Aug. 29, 2019

(54) STRIPLINE AND MICROSTRIP TRANSMISSION LINES FOR QUBITS

(71) Applicant: Intel Corporation, Santa Clara, CA (US)

(72) Inventors: Jeanette M. Roberts, North Plains, OR (US); Ravi Pillarisetty, Portland, OR (US); David J. Michalak, Portland, OR (US); Zachary R. Yoscovits, Beaverton, OR (US); James S. Clarke, Portland, OR (US); Stefano Pellerano, Beaverton, OR (US)

(73) Assignee: Intel Corporation, Santa Clara, CA (US)

(21) Appl. No.: 16/320,203

(22) PCT Filed: Aug. 15, 2016
(86) PCT No.: PCT/US2016/046956

§ 371 Date: Jan. 24, 2019

(51) Int. Cl. H01P 3/08; H01P 11/00; G06N 10/00

(52) U.S. Cl. CPC H01P 3/08; G06N 10/00; H01P 11/003; H01P 3/081

(57) ABSTRACT

Described herein are new transmission line structures for use as resonators and non-resonant interconnects in quantum circuits. In one aspect of the present disclosure, a proposed structure includes a substrate, a ground plane disposed over the substrate, a dielectric layer disposed over the ground plane, and a conductor strip disposed over the dielectric layer. In another aspect, a proposed structure includes a substrate, a lower ground plane disposed over the substrate, a lower dielectric layer disposed over the lower ground plane, a conductor strip disposed over the lower dielectric layer, an upper dielectric layer disposed over the conductor strip, and an upper ground plane disposed over the upper dielectric layer. Transmission line structures as proposed herein could be used for providing microwave connectivity to, from, or/and between the qubits, or to set the frequencies that address individual qubits. Methods for fabricating such structures are disclosed as well.

### CROSS-REFERENCE TO RELATED APPLICATIONS

This application is a national stage application under 35 U.S.C. § 371 of PCT Application PCT/US2016/046956, filed Aug. 15, 2016, and entitled “STRIPLINE AND MICROSTRIP TRANSMISSION LINES FOR QUBITS,” which is hereby incorporated by reference in its entirety.

### TECHNICAL FIELD

This disclosure relates generally to the field of quantum computing, and more specifically, to transmission lines for use in quantum circuits and to methods of fabricating thereof.

### BACKGROUND

Quantum computing refers to the field of research related to computation systems that use quantum mechanical phenomena to manipulate data. These quantum mechanical phenomena, such as superposition (in which a quantum variable can simultaneously exist in multiple different states) and entanglement (in which multiple quantum variables have related states irrespective of the distance between them in space or time), do not have analogs in the world of classical computing, and thus cannot be implemented with classical computing devices.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 provides a schematic illustration of an example quantum circuit, according to some embodiments of the present disclosure.

FIG. 2 provides a schematic illustration of an example quantum computing device that may include any of the transmission lines described herein, according to some embodiments of the present disclosure.

FIGS. 3A and 3B provide a schematic illustration of a coplanar waveguide provided over a substrate.

FIGS. 4A-4Q provide a schematic illustration of fabricating microstrip and stripline transmission lines for qubits, according to some embodiments of the present disclosure.

FIGS. 5A-5D provide a flow chart of a method for fabricating microstrip and stripline transmission lines for qubits, according to some embodiments of the present disclosure.

FIGS. 6A and 6B provide schematic illustrations of exemplary TEM/SEM images of, respectively, a microstrip line and a stripline in a quantum circuit, according to some embodiments of the present disclosure.

### DETAILED DESCRIPTION

As previously described herein, quantum computing, or quantum information processing, refers to the field of research related to computation systems that use quantum-mechanical phenomena to manipulate data. One example of quantum-mechanical phenomena is the principle of quantum superposition, which asserts that any two or more quantum states can be added together, i.e. superposed, to produce another valid quantum state, and that any quantum state can be represented as a sum of two or more other distinct states. Quantum entanglement is another example of quantum-mechanical phenomena. Entanglement refers to groups of particles being generated or interacting in such a way that the state of one particle becomes intertwined with that of the others. Furthermore, the quantum state of each particle cannot be described independently. Instead, the quantum state is given for the group of entangled particles as a whole. Yet another example of quantum-mechanical phenomena is sometimes described as a “collapse” because it asserts that when we observe (measure) particles, we unavoidably change their properties in that, once observed, the particles cease to be in a state of superposition or entanglement (i.e. by trying to ascertain anything about the particles, we collapse their state).

Put simply, superposition postulates that a given particle can be simultaneously in two states, entanglement postulates that two particles can be related in that they are able to instantly coordinate their states irrespective of the distance between them in space and time, and collapse postulates that when one observes a particle, one unavoidably changes the state of the particle and its' entanglement with other particles. These unique phenomena make manipulation of data in quantum computers significantly different from that of classical computers (i.e. computers that use phenomena of classical physics). Classical computers encode data into binary values, commonly referred to as bits. At any given time, a bit is always in only one of two states—it is either 0 or 1. Quantum computers use so-called quantum bits, referred to as qubits (both terms “bits” and “qubits” often interchangeably refer to the values that they hold as well as to the actual devices that store the values). Similar to a bit of a classical computer, at any given time, a qubit can be either 0 or 1. However, in contrast to a bit of a classical computer, a qubit can also be 0 and 1 at the same time, which is a result of superposition of quantum states. Entanglement also contributes to the unique nature of qubits in that input data to a quantum processor can be spread out among entangled qubits, allowing manipulation of that data to be spread out as well: providing input data to one qubit results in that data being shared to other qubits with which the first qubit is entangled.

Compared to well-established and thoroughly researched classical computers, quantum computing is still in its infancy, with the highest number of qubits in a solid-state quantum processor currently being about 10. One of the main challenges resides in protecting qubits from decoherence so that they can stay in their information-holding states long enough to perform the necessary calculations and read out the results. For this reason, materials, structures, and fabrication methods used for building quantum circuits continuously focus on reducing spurious (i.e. unintentional and undesirable) two-level systems (TLS's), thought to be the dominant source of qubit decoherence. In general, as used in quantum mechanics, a two-level (also referred to as “two-state”) system is a system that can exist in any quantum superposition of two independent and physically distinguishable quantum states. Another challenge that is unique to quantum computing is the ability to provide substantially lossless connectivity between qubits at very low powers, e.g. as low as a power of a single photon that may be present in a particular resonator interconnecting two qubits.

As the foregoing illustrates, ability to manipulate and read out quantum states, making quantum-mechanical phenomena visible and traceable, and ability to deal with and improve on the fragility of quantum states of a qubit present unique challenges not found in classical computers. These challenges explain why so many current efforts of the industry and the academics continue to focus on a search for new and improved physical systems whose functionality could approach that expected of theoretically designed qubits. Physical systems for implementing qubits that have been explored until now include e.g. superconducting qubits, single trapped ion qubits, Silicon (Si) quantum dot qubits, photon polarization qubits, etc.

Quantum circuits based on various physical systems for implementing qubits use microwave transmission line resonators to control the qubits. In order to provide substantially lossless connectivity to, from, and between the qubits, such resonators are typically made from superconducting materials. Conventionally, such resonators have been implemented as coplanar waveguides (CPWs).

Inventors of the present disclosure realized that, when used in quantum circuits, employing a conventional CPW architecture may have drawbacks.

Embodiments of the present disclosure propose new transmission line structures for use as resonators, as well as for use as non-resonant interconnects, in quantum circuits. Fabrication techniques for forming such structures are also disclosed.

In one aspect of the present disclosure, a proposed transmission line structure includes a substrate, a ground plane structure disposed over the substrate, a dielectric layer disposed over the ground plane structure, and a conductor strip structure (i.e. a strip of a conductive material, preferably a superconductive material) disposed over the dielectric layer. In the following, “transmission line structure,” “ground plane structure,” and “conductor strip structure” may be referred to without using the word “structure.” Furthermore, the term “conductor strip” may be used interchangeably with the terms such as “signal line,” “signal path,” or “center line” as known in microwave engineering. In such an aspect of the present disclosure, there is a single ground plane for a given conductor strip and the conductor strip is separated from the ground plane by the dielectric layer. Such a transmission line may be referred to as a “microstrip line.”

In another aspect of the present disclosure, a proposed transmission line includes a substrate, a lower ground plane disposed over the substrate, a lower dielectric layer disposed over the lower ground plane, a conductor strip disposed over the lower dielectric layer, an upper dielectric layer disposed over the conductor strip, and an upper ground plane disposed over the upper dielectric layer. Thus, in such an aspect of the present disclosure, there are two ground planes for a given conductor strip and the conductor strip is separated from each ground plane by a respective dielectric layer (i.e. a conductor strip is provided in between, or sandwiched by, the two ground planes). Such a transmission line may be referred to as a “stripline.”

In general, transmission line structures as proposed herein could be used for providing microwave connectivity to, from, or/and between the qubits, or to set the frequencies that address individual qubits.

For the purposes of the present disclosure, the terms such as “upper,” “lower,” “over,” “under,” “between,” and “on” as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening layers.

The phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. As used herein, the notation “A/B/C” means (A), (B), and/or (C).

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. The accompanying drawings are not necessarily drawn to scale.

As used herein, terms indicating what may be considered an idealized behavior, such as e.g. “superconducting” or “lossless”, are intended to cover functionality that may not be exactly ideal but is within acceptable margins for a given application. For example, a certain level of loss, either in terms of non-zero electrical resistance or non-zero amount of spurious TLS's may be acceptable such that the resulting materials and structures may still be referred to by these “idealized” terms. One metric of interest may be the decay rate associated with these losses (e.g. losses either from TLS's or residual resistance), and as long as the decay rate associated with these mechanisms is not worse than needed in order to achieve a fault-tolerant quantum calculation, then the losses are deemed acceptable and the idealized terms (e.g. superconducting or lossless)—appropriate. Specific values associated with an acceptable decay are expected to change over time as fabrication precision will improve and as fault-tolerant schemes may become more tolerant of higher decay rates. An adapted version of this metric, as well as other metrics suitable for a particular application in determining whether certain behavior may be referred to using idealized terms, are within the scope of the present disclosure.

Furthermore, while the present disclosure includes references to microwave signals, this is done only because current qubits are designed to work with such signals because the energy in the microwave range is higher than thermal excitations at the temperature that qubits are operated at. In addition, techniques for the control and measurement of microwaves are well known. For these reasons, typical frequencies of qubits are in 5-10 gigahertz (GHz) range, in order to be higher than thermal excitations, but low enough for ease of microwave engineering. However, advantageously, because excitation energy of qubits is controlled by the circuit elements, qubits can be designed to have any frequency. Therefore, in general, qubits could be designed to operate with signals in other ranges of electromagnetic spectrum and embodiments of the present disclosure could be modified accordingly. All of these alternative implementations are within the scope of the present disclosure.

In the following detailed description, reference is made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Furthermore, in the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure. However, the order of description should not be construed to imply that these operations are necessarily order dependent. In particular, these operations need not be performed in the order of presentation. Operations described may be performed in a different order from the described embodiment(s). Various additional operations may be performed, and/or described operations may be omitted in additional embodiments.

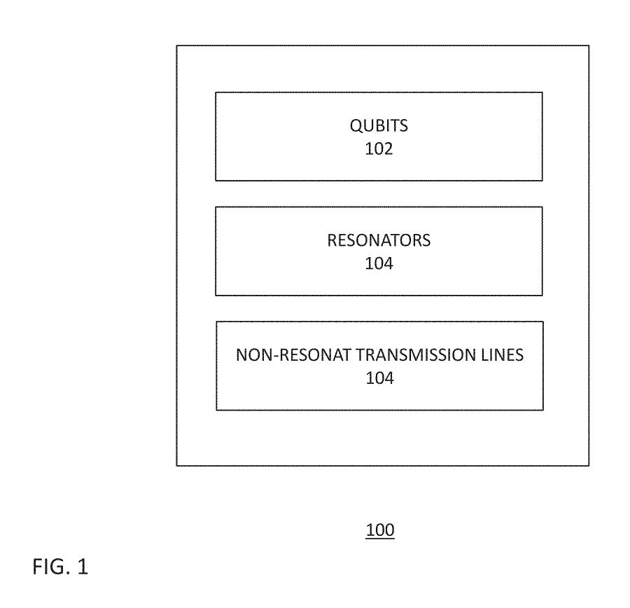

FIG. 1 provides a schematic illustration of a quantum circuit 100 that may include any of the transmission lines described herein, according to some embodiments of the present disclosure. As shown in FIG. 1, an exemplary quantum circuit 100 includes a plurality of qubits 102. The qubits 102 may be implemented as any of the suitable qubits, such as e.g. transmons, quantum well qubits, or quantum dot qubits.

As also shown in FIG. 1, an exemplary quantum circuit 100 typically includes a plurality of resonators 104, e.g. coupling and readout resonators.

Coupling resonators allow coupling different qubits together in order to realize quantum logic gates. A coupling resonator may be implemented as a microwave transmission line that includes capacitive connections to ground on both sides (i.e. a half wavelength resonator), which results in oscillations (resonance) within the transmission line. Each side of a coupling resonator is coupled, either capacitively or inductively, to a respective (i.e. different) qubit by being in sufficient proximity to the qubit. Because each side of a coupling resonator has coupling with a respective different qubit, the two qubits are coupled together through the coupling resonator. In this manner, state of one qubit depends on the state of the other qubit, and the other way around. Thus, coupling resonators may be employed in order to use a state of one qubit to control a state of another qubit, a necessary functionality for implementing logic gates.

Readout resonators may be used to read the state(s) of qubits. In some embodiments, a corresponding readout resonator may be provided for each qubit. A readout resonator is similar to a coupling resonator in that it may be implemented as a transmission line that includes a capacitive connection to ground on one side. On the other side, a readout resonator may either have a capacitive connection to ground (for a half wavelength resonator) or may be shorted to the ground (for a quarter wavelength resonator), which also results in oscillations within the transmission line, with the resonant frequency of the oscillations being close to the frequency of the qubit. A readout resonator is coupled to a qubit by being in sufficient proximity to the qubit, again, either through capacitive or inductive coupling. Due to a coupling between a readout resonator and a qubit, changes in the state of the qubit result in changes of the resonant frequency of the readout resonator. In turn, changes in the resonant frequency of the readout resonator can be read externally via e.g. wire bonding pads.

At least some of the resonators 104 shown in FIG. 1 may be implemented as resonant transmission lines in the form of stripline or microstrip line structures as described herein.

Coupling resonators and readout resonators 104 may be considered as interconnects for supporting propagation of microwave signals in a quantum circuit. In addition to such resonant structures, a typical quantum circuit also includes non-resonant microwave transmission lines for providing microwave signals to different quantum circuit elements and components, such as e.g. flux bias lines, microwave lines, or drive lines, collectively indicated in FIG. 1 as non-resonant transmission lines 106. At least some of the non-resonant transmission lines 106 shown in FIG. 1 may be implemented as non-resonant transmission lines in the form of stripline or microstrip line structures as described herein.

In general, resonators 104 differ from non-resonant microwave transmission lines 106 in that the resonators are configured for capacitive coupling to other circuit elements at one or both ends in order to have resonant oscillations, whereas non-resonant transmission lines such as e.g. flux bias lines and microwave lines may be similar to conventional microwave transmission lines because there is no resonance in these lines.

The non-resonant transmission lines may also be considered as being included within a broad category of interconnects.

Further, any other connections for providing microwave or other electrical signals to different quantum circuit elements and components, such as e.g. connections between electrodes of various circuit components, or connections between two ground lines of a particular transmission line for equalizing electrostatic potential on the two ground lines, are also referred to herein as interconnects. Still further, the term “interconnect” may also be used to refer to elements providing electrical interconnections to/from/between quantum circuit elements and components and non-quantum circuit elements, which may also be provided in a quantum circuit, as well as to electrical interconnections between various non-quantum circuit elements provided in a quantum circuit. Examples of non-quantum circuit elements which may be provided in a quantum circuit may include various analog and/or digital systems, e.g. analog to digital converters, mixers, multiplexers, amplifiers, etc.

In various embodiments, the interconnects included in a quantum circuit could have different shapes and layouts. In general, the term “line” as used herein in context of signal lines or transmission lines does not imply straight lines, unless specifically stated so. For example, some transmission lines or parts thereof (e.g. conductor strips of transmission lines) may comprise more curves and turns while other transmission lines or parts thereof may comprise less curves and turns, and some transmission lines or parts thereof may comprise substantially straight lines. In some embodiments, various interconnects may intersect one another, in such a manner that they don't make an electrical connection, which can be done by using e.g. a bridge, bridging one interconnect over the other.

In some embodiments, materials forming the interconnects include aluminum (Al), niobium (Nb), niobium nitride (NbN), titanium nitride (TiN), and niobium titanium nitride (NbTiN), all of which are particular types of superconductors. However, in various embodiments, other suitable superconductors may be used as well.

The qubits 102, the resonators 104, and the non-resonant transmission lines 106 of the quantum circuit 100 may be provided on, over, or at least partially embedded in a substrate (not shown in FIG. 1).

In various embodiments, quantum circuits such as the one shown in FIG. 1 may be used to implement components associated with a quantum integrated circuit (IC). Such components may include those that are mounted on or embedded in a quantum IC, or those connected to a quantum IC. The quantum IC may be either analog or digital and may be used in a number of applications within or associated with quantum systems, such as e.g. quantum processors, quantum amplifiers, quantum sensors, etc., depending on the components associated with the integrated circuit. The integrated circuit may be employed as part of a chipset for executing one or more related functions in a quantum system.

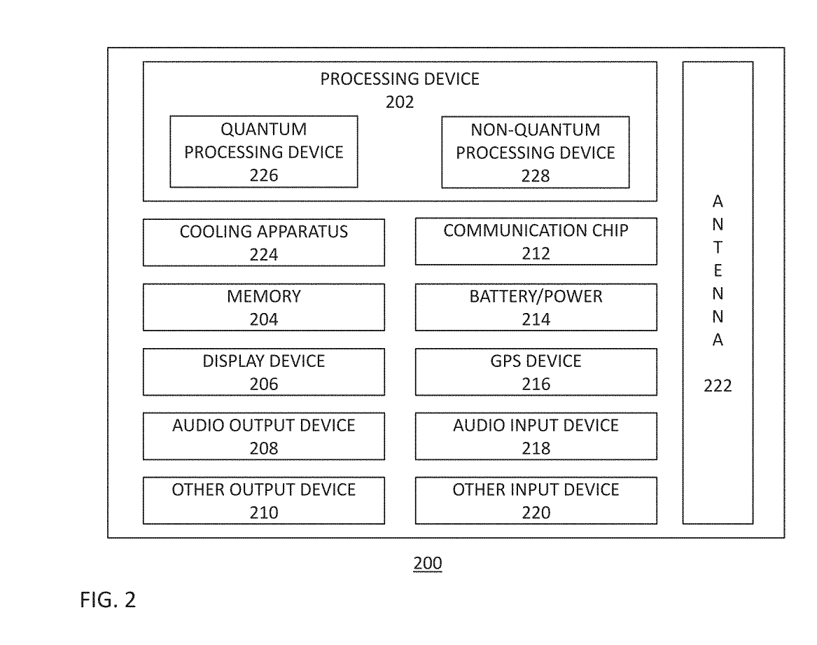

FIG. 2 provides an illustration of an exemplary quantum computing device that may include any of the transmission lines in the form of stripline or microstrip line structures described herein, e.g. a quantum computer, 200, according to some embodiments of the present disclosure.

A number of components are illustrated in FIG. 2 as included in the quantum computing device 200, but any one or more of these components may be omitted or duplicated, as suitable for the application. In some embodiments, some or all of the components included in the quantum computing device 200 may be attached to one or more printed circuit boards (e.g., a motherboard). In some embodiments, various ones of these components may be fabricated onto a single system-on-a-chip (SoC) die. Additionally, in various embodiments, the quantum computing device 200 may not include one or more of the components illustrated in FIG. 2, but the quantum computing device 200 may include interface circuitry for coupling to the one or more components. For example, the quantum computing device 200 may not include a display device 206, but may include display device interface circuitry (e.g., a connector and driver circuitry) to which a display device 206 may be coupled. In another set of examples, the quantum computing device 200 may not include an audio input device 218 or an audio output device 208, but may include audio input or output device interface circuitry (e.g., connectors and supporting circuitry) to which an audio input device 218 or audio output device 208 may be coupled.

The quantum computing device 200 may include a processing device 202 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 202 may include a quantum processing device 226 (e.g., one or more quantum processing devices), and a non-quantum processing device 228 (e.g., one or more non-quantum processing devices). The quantum processing device 226 may include one or more of the quantum circuits 100 disclosed herein, and may perform data processing by performing operations on the qubits 102 that may be generated in the quantum circuits 100, and monitoring the result of those operations. For example, as discussed above, different qubits may be allowed to interact, the quantum states of different qubits may be set or transformed, and the quantum states of qubits may be read (e.g., by another qubit via a coupling resonator or externally via a readout resonator). The quantum processing device 226 may be a universal quantum processor, or specialized quantum processor configured to run one or more particular quantum algorithms. In some embodiments, the quantum processing device 226 may execute algorithms that are particularly suitable for quantum computers, such as cryptographic algorithms that utilize prime factorization, encryption/decryption, algorithms to optimize chemical reactions, algorithms to model protein folding, etc. The quantum processing device 226 may also include support circuitry to support the processing capability of the quantum processing device 226, such as input/output channels, multiplexers, signal mixers, quantum amplifiers, and analog-to-digital converters.

As noted above, the processing device 202 may include a non-quantum processing device 228. In some embodiments, the non-quantum processing device 228 may provide peripheral logic to support the operation of the quantum processing device 226. For example, the non-quantum processing device 228 may control the performance of a read operation, control the performance of a write operation, control the clearing of quantum bits, etc. The non-quantum processing device 228 may also perform conventional computing functions to supplement the computing functions provided by the quantum processing device 226. For example, the non-quantum processing device 228 may interface with one or more of the other components of the quantum computing device 200 (e.g., the communication chip 212 discussed below, the display device 206 discussed below, etc.) in a conventional manner, and may serve as an interface between the quantum processing device 226 and conventional components. The non-quantum processing device 228 may include one or more digital signal processors (DSPs), application-specific integrated circuits (ASICs), central processing units (CPUs), graphics processing units (GPUs), crypto processors (specialized processors that execute cryptographic algorithms within hardware), server processors, or any other suitable processing devices.

The quantum computing device 200 may include a memory 204, which may itself include one or more memory devices such as volatile memory (e.g., dynamic random access memory (DRAM)), nonvolatile memory (e.g., read-only memory (ROM)), flash memory, solid state memory, and/or a hard drive. In some embodiments, the states of qubits in the quantum processing device 226 may be read and stored in the memory 204. In some embodiments, the memory 204 may include memory that shares a die with the non-quantum processing device 228. This memory may be used as cache memory and may include embedded dynamic random access memory (eDRAM) or spin transfer torque magnetic random-access memory (STT-MRAM).

The quantum computing device 200 may include a cooling apparatus 224. The cooling apparatus 224 may maintain the quantum processing device 226 at a predetermined low temperature during operation to reduce the effects of scattering in the quantum processing device 226. This predetermined low temperature may vary depending on the setting; in some embodiments, the temperature may be 5 degrees Kelvin or less. In some embodiments, the non-quantum processing device 228 (and various other components of the quantum computing device 200) may not be cooled by the cooling apparatus 224, and may instead operate at room temperature. The cooling apparatus 224 may be, for example, a dilution refrigerator, a helium-3 refrigerator, or a liquid helium refrigerator.

In some embodiments, the quantum computing device 200 may include a communication chip 212 (e.g., one or more communication chips). For example, the communication chip 212 may be configured for managing wireless communications for the transfer of data to and from the quantum computing device 200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 212 may implement any of a number of wireless standards or protocols, including but not limited to Institute for Electrical and Electronic Engineers (IEEE) standards including Wi-Fi (IEEE 1402.11 family), IEEE 1402.16 standards (e.g., IEEE 1402.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 1402.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 1402.16 standards. The communication chip 212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 212 may operate in accordance with other wireless protocols in other embodiments. The quantum computing device 200 may include an antenna 222 to facilitate wireless communications and/or to receive other wireless communications (such as AM or FM radio transmissions).

In some embodiments, the communication chip 212 may manage wired communications, such as electrical, optical, or any other suitable communication protocols (e.g., the Ethernet). As noted above, the communication chip 212 may include multiple communication chips. For instance, a first communication chip 212 may be dedicated to shorter-range wireless communications such as Wi-Fi or Bluetooth, and a second communication chip 212 may be dedicated to longer-range wireless communications such as GPS, EDGE, GPRS, CDMA, WiMAX, LTE, EV-DO, or others. In some embodiments, a first communication chip 212 may be dedicated to wireless communications, and a second communication chip 212 may be dedicated to wired communications.

The quantum computing device 200 may include battery/power circuitry 214. The battery/power circuitry 214 may include one or more energy storage devices (e.g., batteries or capacitors) and/or circuitry for coupling components of the quantum computing device 200 to an energy source separate from the quantum computing device 200 (e.g., AC line power).

The quantum computing device 200 may include a display device 206 (or corresponding interface circuitry, as discussed above). The display device 206 may include any visual indicators, such as a heads-up display, a computer monitor, a projector, a touchscreen display, a liquid crystal display (LCD), a light-emitting diode display, or a flat panel display, for example.

The quantum computing device 200 may include an audio output device 208 (or corresponding interface circuitry, as discussed above). The audio output device 208 may include any device that generates an audible indicator, such as speakers, headsets, or earbuds, for example.

The quantum computing device 200 may include an audio input device 218 (or corresponding interface circuitry, as discussed above). The audio input device 218 may include any device that generates a signal representative of a sound, such as microphones, microphone arrays, or digital instruments (e.g., instruments having a musical instrument digital interface (MIDI) output).

The quantum computing device 200 may include a global positioning system (GPS) device 216 (or corresponding interface circuitry, as discussed above). The GPS device 216 may be in communication with a satellite-based system and may receive a location of the quantum computing device 200, as known in the art.

The quantum computing device 200 may include an other output device 210 (or corresponding interface circuitry, as discussed above). Examples of the other output device 210 may include an audio codec, a video codec, a printer, a wired or wireless transmitter for providing information to other devices, or an additional storage device.

The quantum computing device 200 may include an other input device 220 (or corresponding interface circuitry, as discussed above). Examples of the other input device 220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The quantum computing device 200, or a subset of its components, may have any appropriate form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device.

In order to highlight the advantages offered by novel quantum circuit transmission line structures proposed herein, it would be helpful to first explain how conventional quantum circuit microwave resonators are implemented.

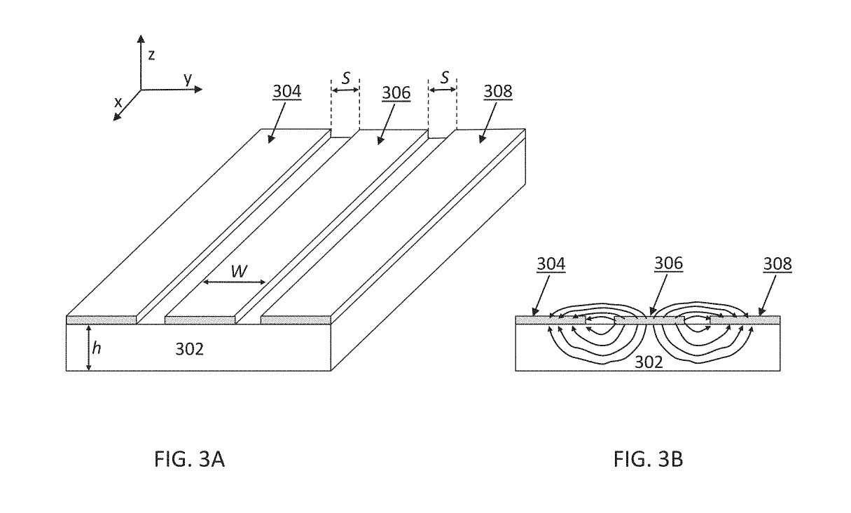

As mentioned above, conventionally, quantum circuit resonators have been implemented as coplanar waveguides. An example of a coplanar waveguide (CPW) is shown in FIGS. 3A and 3B providing, respectively, a perspective and a cross-section illustrations. In FIGS. 3A and 3B, a CPW includes two ground planes 304 and 308 and a conductor strip 306 provided in the middle, between the two ground planes. The conductor strip 306 and the ground planes 304 and 308 all lie in the same plane over a dielectric substrate 302. FIG. 3A indicates a height h, which refers to the thickness of the substrate 302, a strip width W of the signal line 306, and slot spaces S between the signal line 306 and each of the ground planes 304 and 308. The height h, strip width W, and slot spaces S are parameters that define characteristics of a CPW transmission line, such as e.g. impedance of the transmission line and electromagnetic field distribution.

FIG. 3B illustrates exemplary electromagnetic field distribution in a CPW architecture, where curved arrows illustrate directions of an exemplary electric field. As can be seen in FIG. 3B, in a CPW, some of the electromagnetic energy is immediately below the transmission line, i.e. within the dielectric substrate 302, while some of the energy can leak out above the transmission line (i.e. in air). Thus, in a CPW, a large portion of the electromagnetic field generated by the transmission line is at interfaces—either at interfaces between the superconducting material of the waveguide and air above the waveguide or at interfaces between the superconducting material of the waveguide and the dielectric of the substrate 302. However, such concentration of the electromagnetic field may be sub-optimal for quantum circuits because interfaces, in particular superconductor-air interfaces, may be one of the causes of spurious TLS's, leading to qubit decoherence.

There are several other reasons why conventional CPW architecture may be not be the most suitable architecture for implementing transmission lines in quantum circuits. One reason is that a conventional CPW architecture as shown in FIGS. 3A-3B does not allow for the fine control of electromagnetic fields and mutual inductances as needed for adequate quantum circuit performance. Another reason is that, because a conventional CPW architecture is two-dimensional by nature, it is difficult to employ in three-dimensional interconnect schemes and such schemes are likely to become necessary if quantum circuits are to be scaled up in order to become commercially feasible. Yet another reason is that using passivation (i.e. a process of treating or coating a material in order to reduce the chemical reactivity of its surface) to encapsulate chips with coplanar waveguides presents challenges.

Embodiments of the present disclosure propose new transmission line structures for use as resonator and non-resonant microwave transmission lines in quantum circuits. Providing ground planes below the signal line, as is done in both microstrip and stripline architectures proposed herein, or below and above the signal line, as is done in stripline architectures proposed herein, may allow concentrating electromagnetic fields within the bulk of the dielectric layer(s). Concentrating electromagnetic fields in the bulk, i.e. further away from the lossy interfaces, may reduce the effects of spurious TLS's, thus improving on the decoherence issues of qubits. Having ground planes below, or both below and above the signal line also allows greater control over the electromagnetic fields, which in turn allows reducing stray electromagnetic fields and mutual inductances. Furthermore, proposed transmission line structures may advantageously allow implementation of three-dimensional interconnect schemes in quantum circuits and reduce difficulties associated with encapsulating chips housing quantum circuits using passivation. If compared to conventional CPW resonators, fabrication techniques for forming the transmission line structures proposed herein reduce uncontrolled interfaces between superconductor (SC) and air because at least some of the superconductors can be hermetically sealed within dielectric(s), which may help with aging issues that quantum circuits employing conventional CPWs currently have.

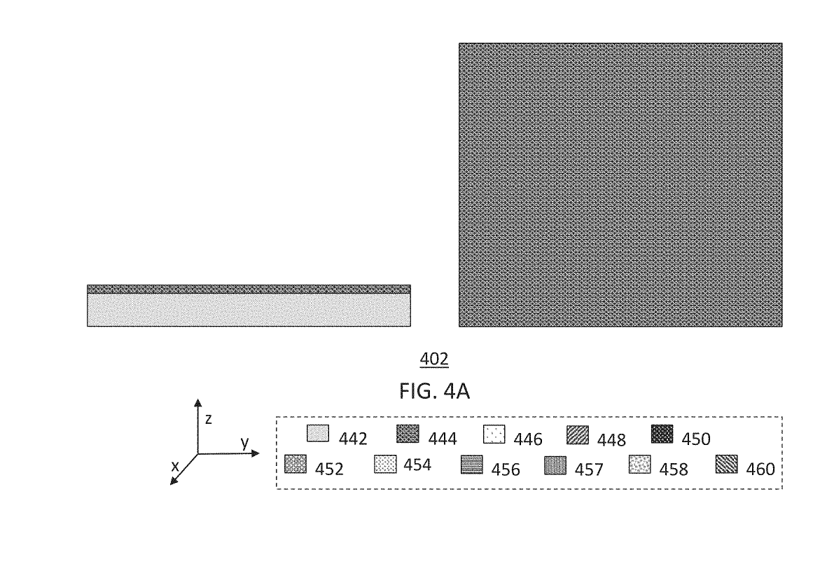

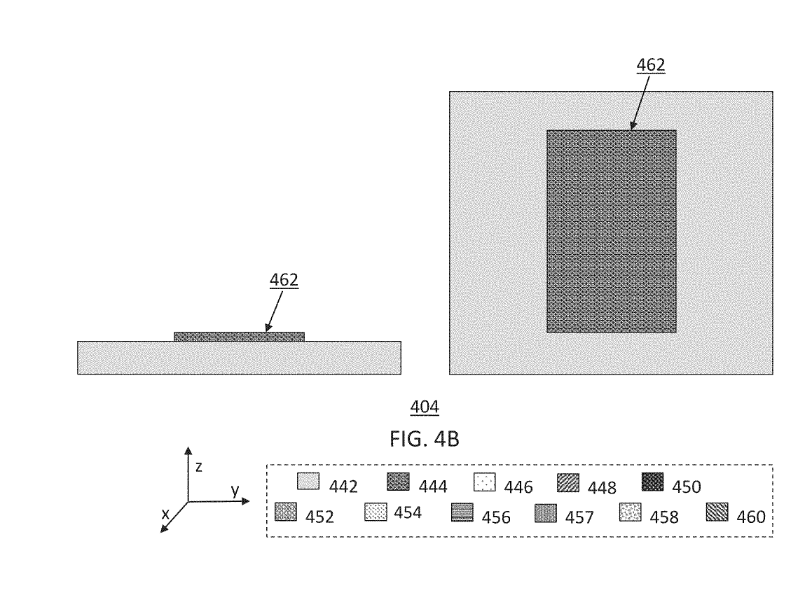

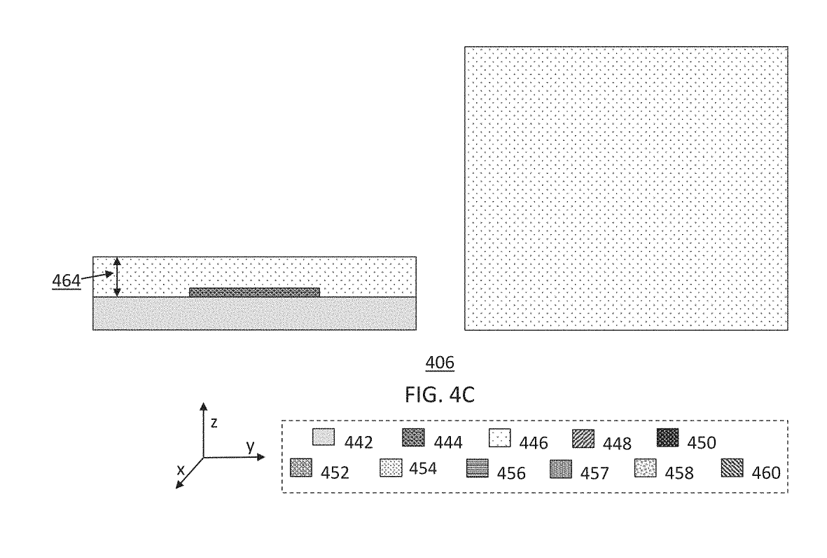

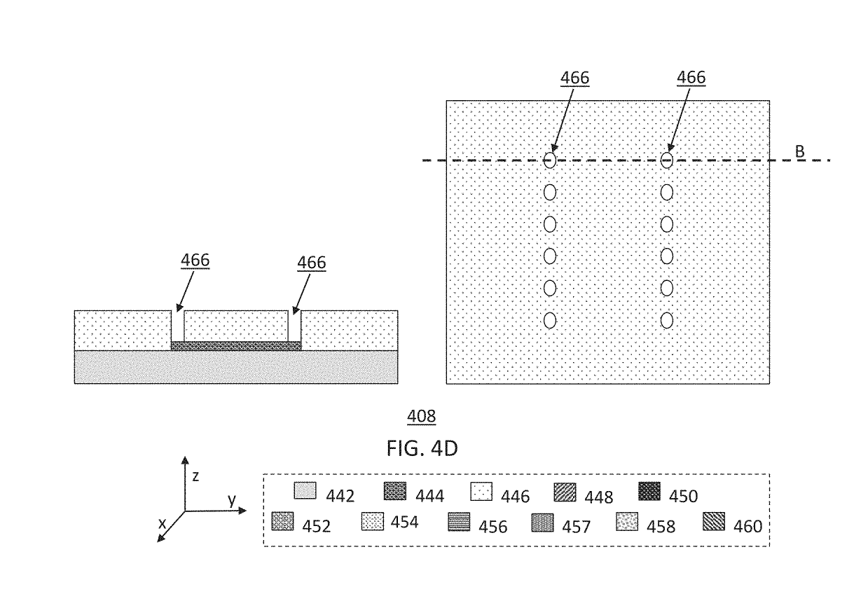

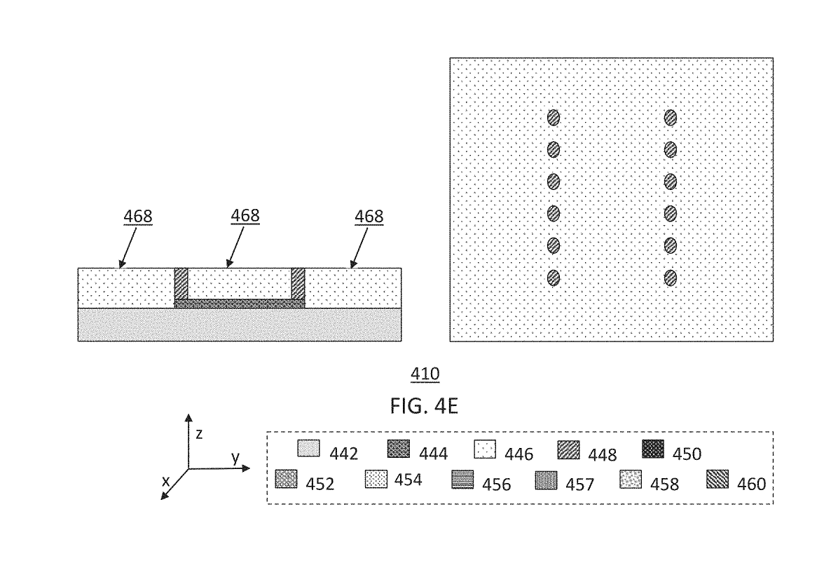

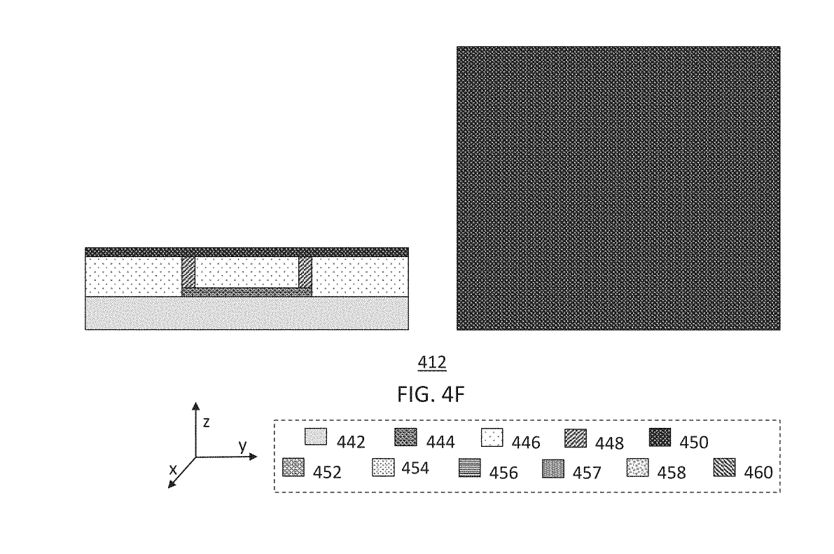

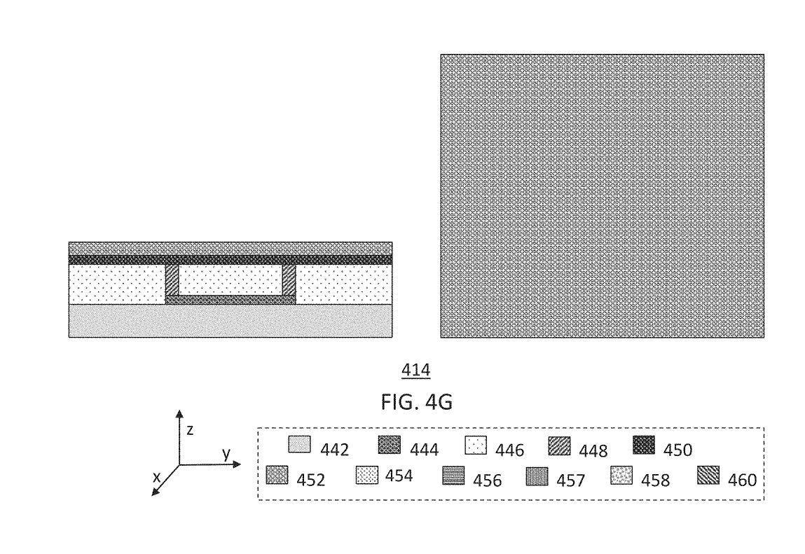

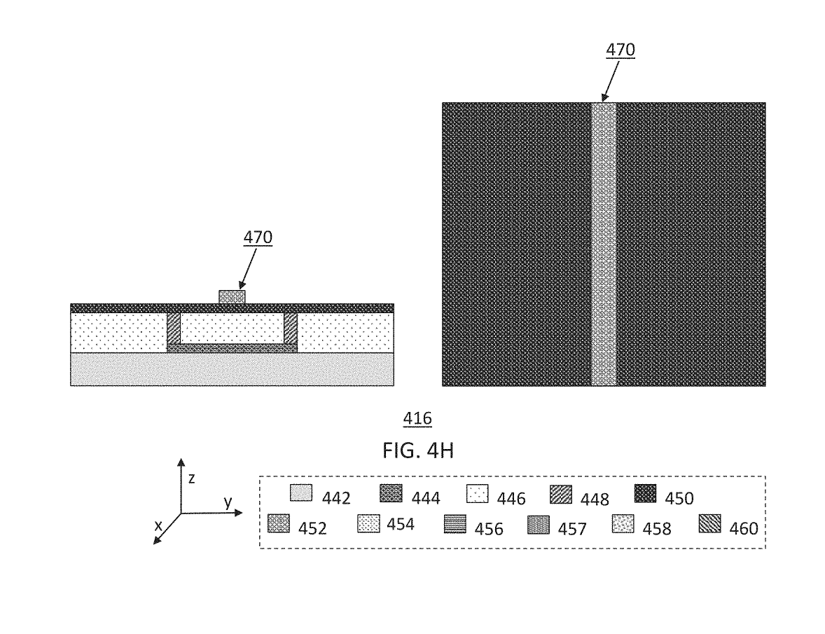

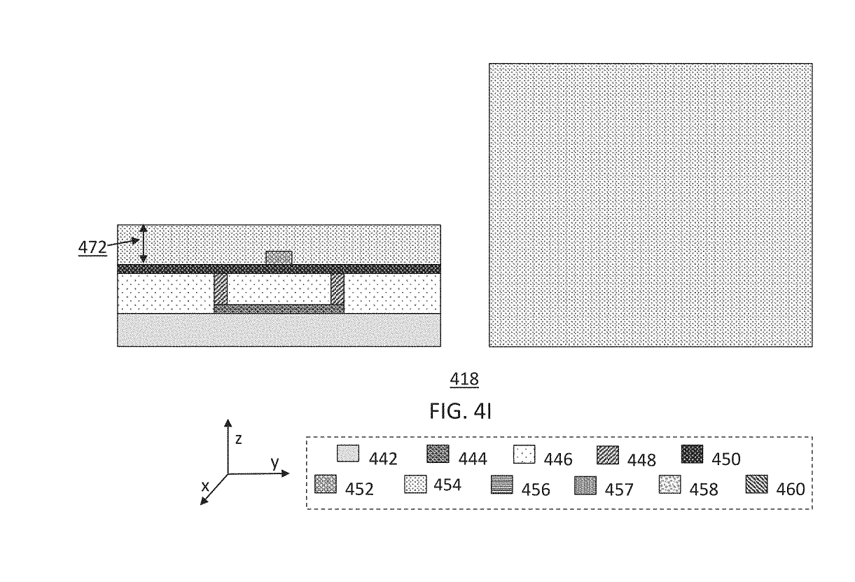

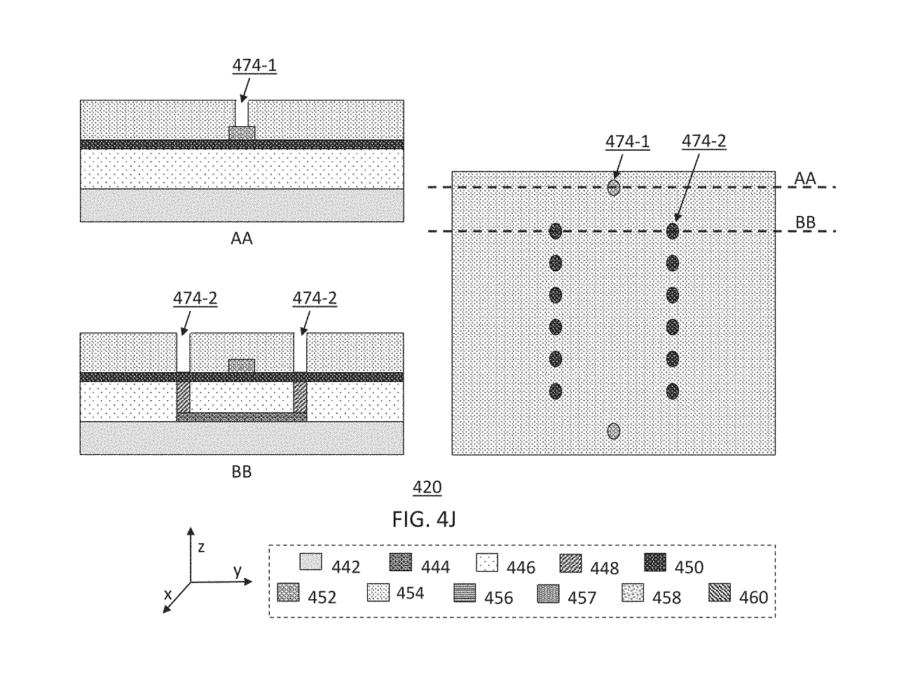

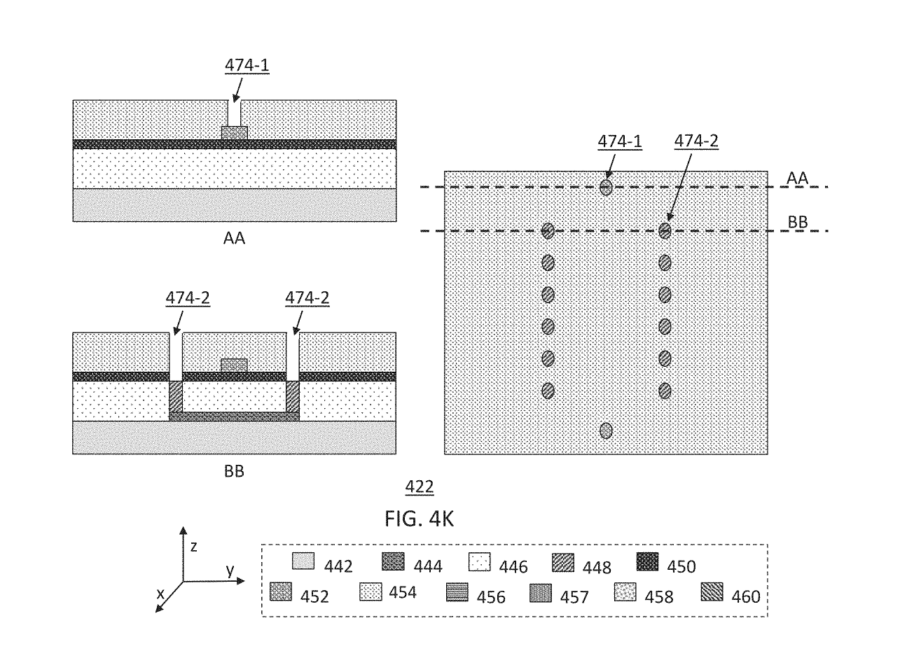

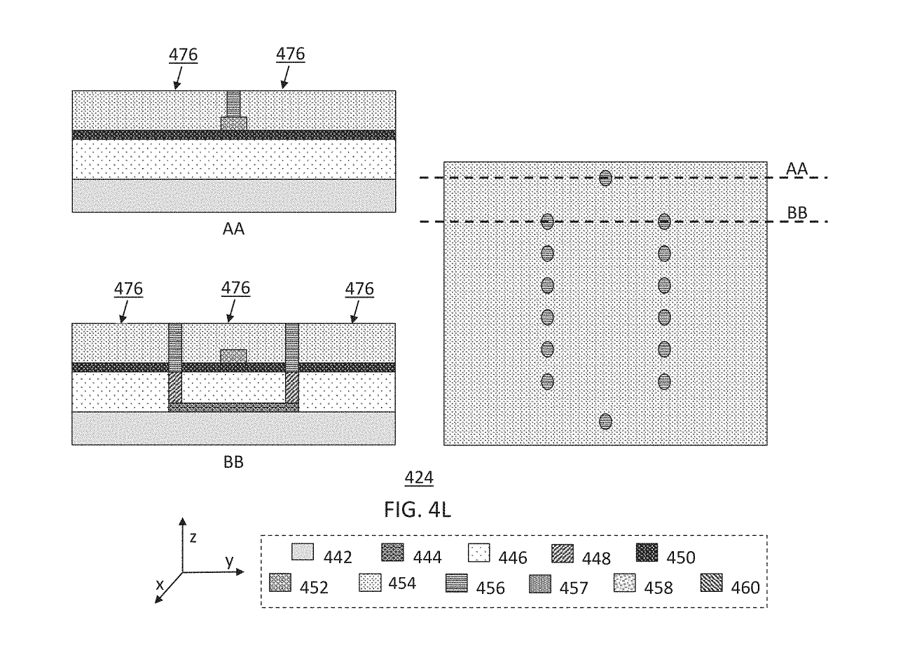

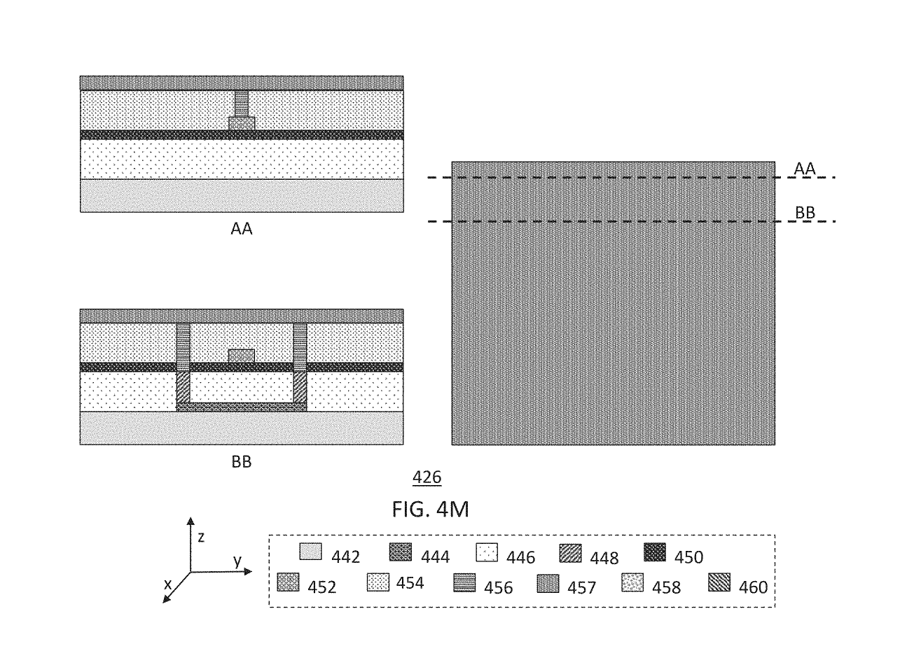

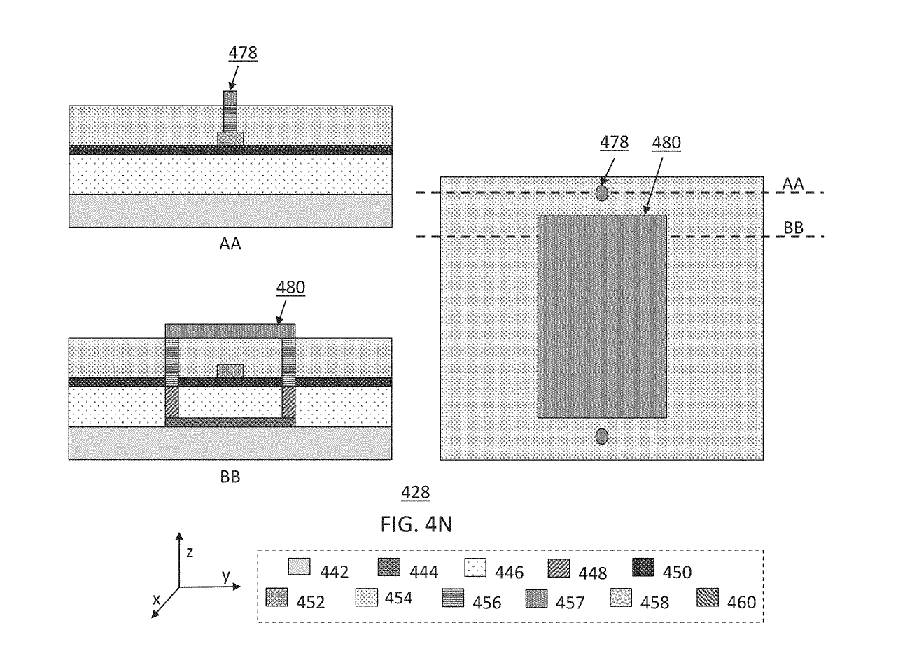

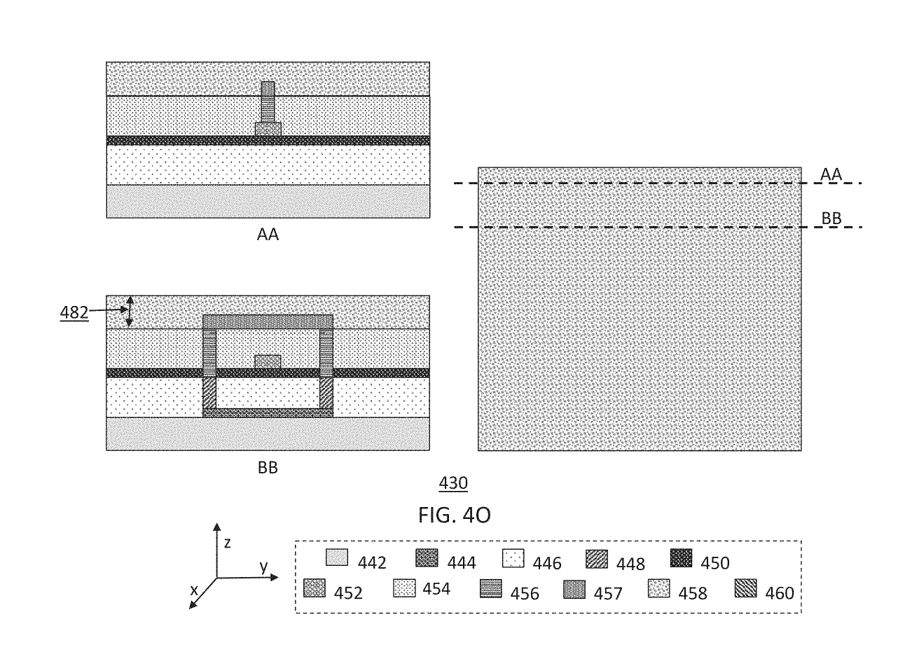

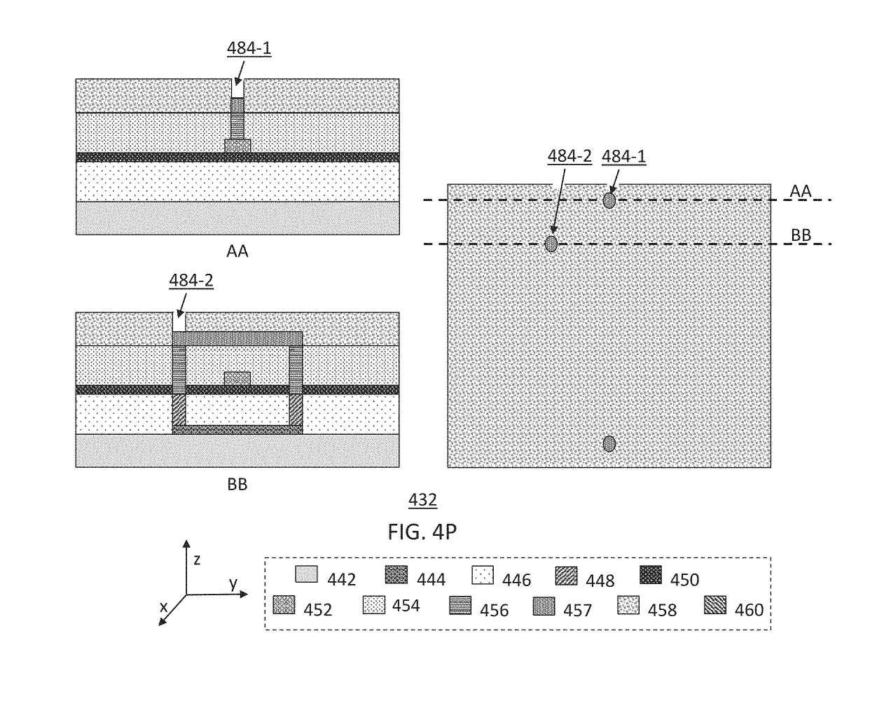

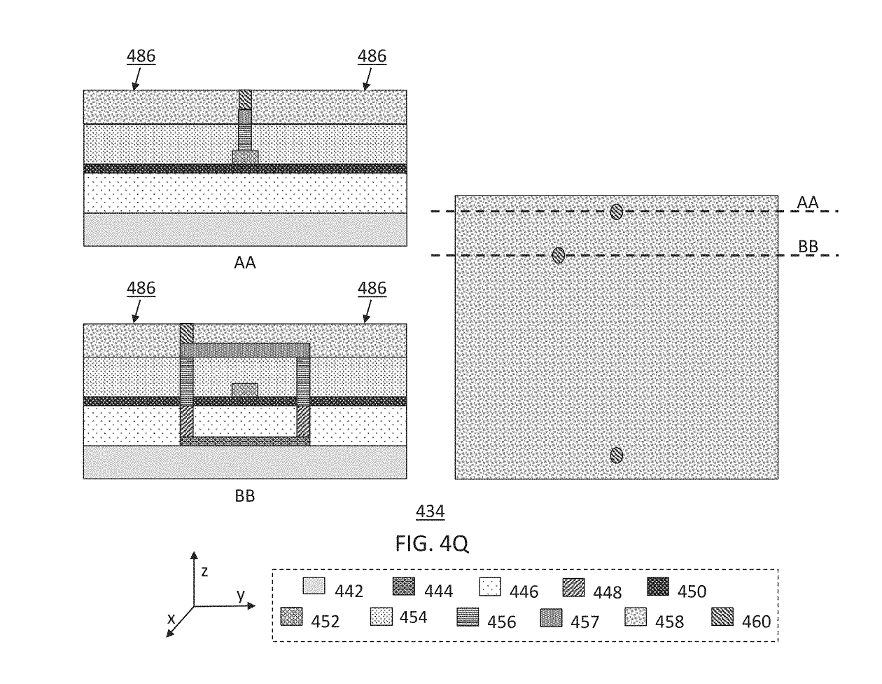

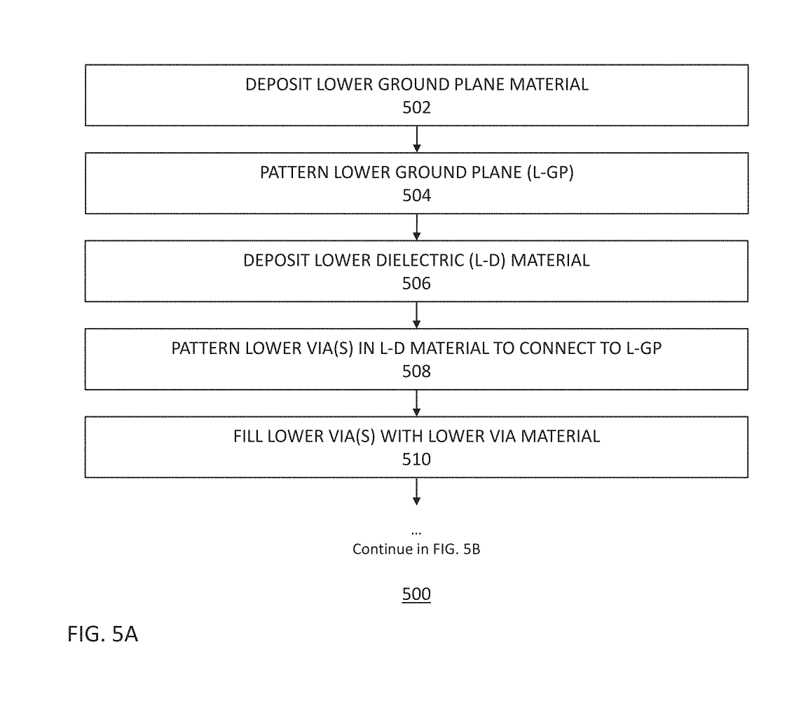

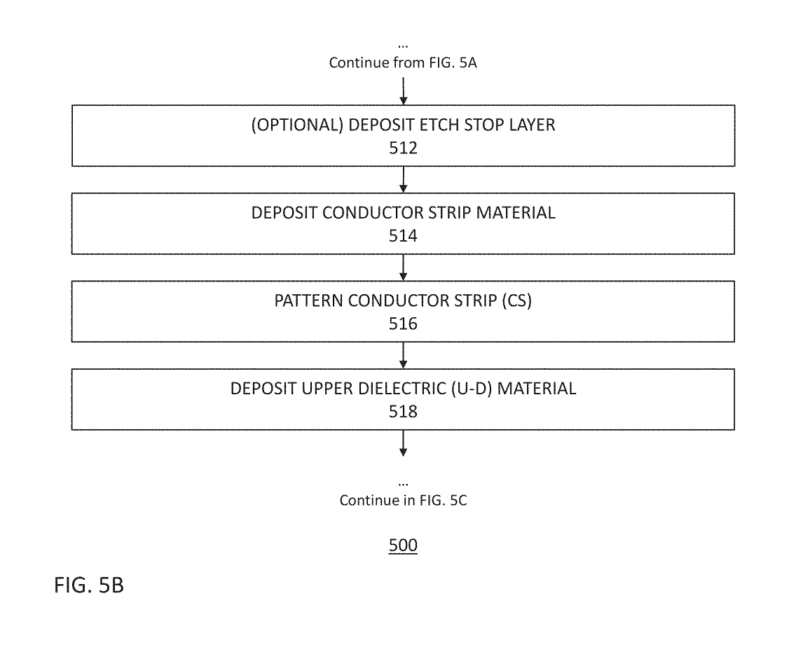

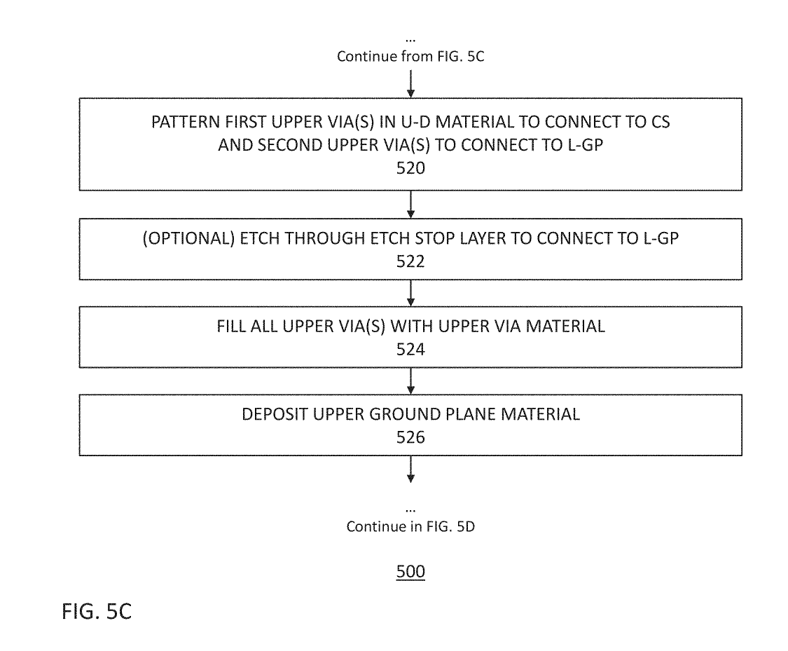

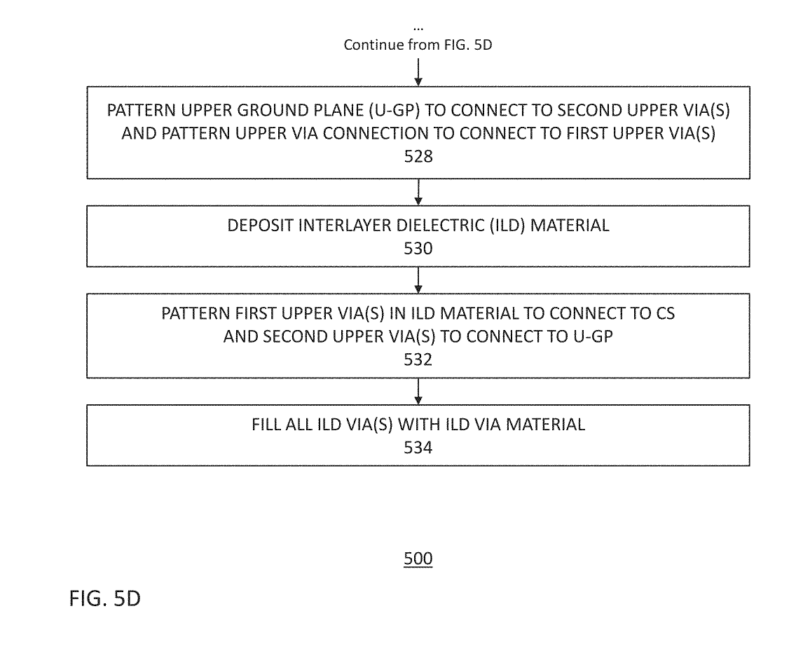

FIGS. 4A-4Q provide a schematic illustration of fabricating microstrip line and stripline transmission lines for qubits, according to some embodiments of the present disclosure. A legend provided within a dashed box at the bottom of FIGS. 4A-4Q illustrates patterns used to indicate different elements shown in FIGS. 4A-4Q, so that the FIGs are not cluttered by many reference numerals. FIGS. 4A-4Q will now be described with reference to FIGS. 5A-5D providing a flow chart of a method 500 for fabricating microstrip line and stripline transmission lines for qubits, according to some embodiments of the present disclosure. In particular, FIGS. 4A-4Q illustrate a sequence of structures 402, 404, 406, 408, and so on until structure 434, each of which illustrates an exemplary result of a corresponding one of different subsequent fabrication processes 502, 504, 506, 508, and so on until step 534 shown in FIG. 5. Thus, each structure 4XX corresponds to a respective process box 5XX of the method 500, e.g. a structure 402 illustrates an exemplary result of a fabrication process 502, a structure 404 illustrates an exemplary result of a fabrication process 504, a structure 406 illustrates an exemplary result of a fabrication process 506, and so on. Furthermore, each of FIGS. 4A-4Q provides two views of the same structure. Namely, the view on the left side of each of FIGS. 4A-4Q is a cross-sectional view with a cross-section of the structures taken along a y-z plane, as e.g. shown for the perspective drawing of a transmission line shown in FIG. 3A, while the view on the right side of each of FIGS. 4A-4Q is a top-down view of an x-y plane.

Although the operations discussed below with reference to the method 500 are illustrated in a particular order and depicted once each, these operations may be repeated or performed in a different order (e.g., in parallel), as suitable. Additionally, various operations may be omitted, as suitable. Various operations of the method 500 may be illustrated with reference to one or more of the embodiments discussed above, but the method 500 may be used to manufacture any suitable quantum circuit element comprising one or more microstrip lines or striplines according to any embodiments disclosed herein.

The method 500 may begin with providing a layer of ground plane material 444 provided over a substrate 442 (process 502 of FIG. 5A, result of which is illustrated with a structure 402 of FIG. 4A).

The substrate 442 may comprise any substrate suitable for realizing quantum circuit components described herein. In one implementation, the substrate 442 may be a crystalline substrate such as, but not limited to a silicon or a sapphire substrate, and may be provided as a wafer or a portion thereof. In other implementations, the substrate may be non-crystalline. In general, any material that provides sufficient advantages (e.g. sufficiently good electrical isolation and/or ability to apply known fabrication and processing techniques) to outweigh the possible disadvantages (e.g. negative effects of spurious TLS's), and that may serve as a foundation upon which a quantum circuit may be built, falls within the spirit and scope of the present disclosure. Additional examples of substrates include silicon-on-insulator (SOI) substrates, III-V substrates, and quartz substrates.

The ground plane material 444 may comprise any conducting or superconducting material suitable for serving as an interconnect in a quantum circuit, such as e.g. aluminum (Al), niobium (Nb), niobum nitride (NbN), niobium titanium nitride (NbTiN), titanium nitride (TiN), molybdenum rhenium (MoRe), etc., or any alloy of two or more superconducting/conducting materials. The ground plane material 444 may be deposited over the substrate 442 using any known techniques for depositing conducting/superconducting materials, such as e.g. atomic layer deposition (ALD), physical vapor deposition (PVD) (e.g. evaporative deposition, magnetron sputtering, or e-beam deposition), chemical vapor deposition (CVD), or electroplating.

In various embodiments, the thickness of the layer of the ground plane material 444 may be between 20 and 500 nanometers (nm) including all values and ranges therein, e.g. between 20 and 300 nm, or between 20 and 200 nm.

As used herein, the term “thickness” refers to a dimension of a certain element or layer as measured along the z-axis as illustrated in FIGS. 4A-4Q, the term “width” refers to a dimension of a certain element or layer as measured along the y-axis as illustrated in FIGS. 4A-4Q, while the term “length” refers to a dimension of a certain element or layer as measured along the x-axis as illustrated in FIGS. 4A-4Q.

The method 500 may proceed with patterning the layer of the ground plane material 444 to form a structure that will serve as a ground plane of a transmission line for one or more qubits (process 504 of FIG. 5A, result of which is illustrated with a structure 404 of FIG. 4B). An example of such structure is shown as a rectangular structure 462 shown in FIG. 4B. However, in other embodiments, the ground plane structure 462 could have any other shapes/geometries suitable for serving as a ground plane conductor of a microstrip line or a stripline, all of which shapes/geometries being within the scope of the present disclosure.

In various embodiments, the width of the ground plane structure 462 may be between 50 nm and 33 millimeters (mm) including all values and ranges therein, typically between 100 and 15 micrometers (micron), e.g. between 300 nm and 15 microns. In general, the width of the ground plane structure is limited by practical application, as the ground planes would be ideally infinite planes. The smallest width of the ground plane could be equal to or slightly larger than the conductor strip, e.g. 50 nm, and the largest width could be that of the chip, e.g. 33 mm. More practically, the width is more likely to be between 300 nm (e.g. for small resonators with high kinetic inductance) and 15 micron.

In some embodiments, the substrate may be cleaned to remove surface-bound organic and metallic contaminants, as well as subsurface contamination. In some embodiments, cleaning may be carried out using e.g. a chemical solutions (such as peroxide), and/or with UV radiation combined with ozone, and/or oxidizing the surface (e.g., using thermal oxidation) then removing the oxide (e.g. using HF).

In various embodiments, any kind of conventional patterning techniques may be used to form the ground plane 462 at the desired locations on the substrate 442, such as e.g. patterning techniques employing photoresist or other masks defining the dimensions and location of the future ground plane conductor 462. An exemplary photoresist patterning technique could include depositing a photoresist over the layer of interest, in this case—over the substrate 442. The photoresist may be a positive or negative resist and may include for example, poly(methyl methacrylate), poly(methyl glutarimide), DNQ/novolac, or SU-8 (an expoxy based negative resist). The photoresist may be chemically amplified containing a photoacid generator and may be based on polymers or co-polymers which contain aromatic rings or alicyclic norbornene derivatives (e.g. for etch resistance), and have protecting groups such as t-butyl. The polymers may include polystyrene or acrylate polymers. The photoresist may be deposited by a casting process such as, for example, spin-coating. The photoresist may then be patterned by optically projecting an image of a desired pattern onto the photoresist using photolithography, such as optical photolithography, immersion photolithography, deep UV lithography, extreme UV lithography, or other techniques. A developer, such as tetramethylammonium hydroxide TMAH (with or without surfactant) at a concentration of in the range of 0.1 N to 0.3 N, may be applied to the photoresist, such as by spin-coating, and portions of the photoresist are removed to expose regions of the underlying layer correlating to the desired pattern. In some embodiments, baking of the substrate may occur before or after any of the above actions. For example, the substrate may be prebaked to remove surface water. After application of the photoresist, a post application bake may occur, wherein at least a portion of the solvents in the photoresist are driven off. After exposure to light, a post-exposure bake may occur to induce chemical reactions, such as de-protecting the photoresist. After patterning, the resist may be hard baked.

Next, a layer of insulating material 446 is provided over the substrate 442 with the ground plane 462 formed thereon (process 506 of FIG. 5A, result of which is illustrated with a structure 406 of FIG. 4C). The insulating material 446 could be selected as any dielectric material suitable for undergoing further fabrication processing described herein. For example, since the dielectric layer 446 will need to later be etched to form vias 466, etching properties of potential candidate materials are to be considered when selecting a suitable material to be used for the layer 446. Besides appropriate etching characteristics, some other considerations in selecting a suitable material may include e.g. possibilities of smooth film formation, low shrinkage and outgassing, and good dielectric properties (such as e.g. low electrical leakage, suitable value of a dielectric constant, and thermal stability). Examples of dielectric materials that may be used as the material of the dielectric layer 446 include, but are not limited to, silicon dioxide (SiO₂), carbon doped oxide (CDO), silicon nitride, organic polymers such as perfluorocyclobutane or polytetrafluoroethylene, fluorosilicate glass (FSG), and organosilicates such as silsesquioxane, siloxane, or organosilicate glass.

In some embodiments, the dielectric material 446 may include an oxide deposited over the ground plane conductor 462 using e.g. chemical vapor deposition or/and plasma-enhanced chemical vapor deposition, as typically done in conventional processing. In still other embodiments, the dielectric material 446 may include a dielectric material formed over the ground plane conductor 462 using coating techniques involving cross-linking of liquid precursors into solid dielectric materials. In some embodiments, the surface of the ground plane conductor 462 may be cleaned or treated prior to applying the dielectric to reduce surface contamination and minimize interface traps and/or promote adhesion, for example using chemical or plasma clean, or applying heat in a controlled environment. In some embodiments, an “interface layer” may be applied between the ground plane conductor 462 and the dielectric material 446 to prevent, decrease, or minimize spontaneous and uncontrolled formation of other interfacial layers. In some embodiments, an adhesion promoter or adhesion layer may be applied prior to application of the dielectric.

Planarization may also be performed in order to achieve a relatively smooth, plane surface of the dielectric layer 446. In various embodiments, planarization may be performed using either wet or dry planarization processes. In one embodiment, planarization may be performed using chemical mechanical planarization (CMP), which may be understood as a process that utilizes a polishing surface, an abrasive and a slurry to remove the overburden and planarize the surface.

A thickness of the dielectric layer 446, e.g. as measured as a thickness 464 shown in FIG. 4C, would depend on e.g. the desired distance between the conductor strip and the ground plane of the future microstrip line or stripline. For example, the dielectric layer 446 may have a thickness between e.g. 20 and 3000 nm, including all values and ranges therein, typically for qubit applications between 0.5 and 1500 nm.

The method 500 may then proceed with forming one or more vias 466 in the dielectric layer 446 to connect to the ground plane 462 (process 508 of FIG. 5A, result of which is illustrated with a structure 408 of FIG. 4D). In order to properly illustrate the via opening, the side view of FIG. 4D is shown as a cross-section along a line that goes through the one or more via openings 466, such as e.g. line B shown in the top view of FIG. 4D.

Number, dimensions and a shape of the vias 466 could depend on e.g. the conductive/superconductive material used to fill the vias, dimensions and shape of the ground plane 464, and the etching process used to form the vias 466. For example, in some embodiments, a plurality of vias arranged along two lines at the edges of the ground plane 462 could be used, as shown in the top view in FIG. 4D. However, in other embodiments, any other number of vias 466, arranged in any location and in any shape/geometry as suitable for providing electrical interconnection to the ground plane conductor 462 of a microstrip line or a stripline may be used, all of which being within the scope of the present disclosure.

The via openings extend from the surface of the dielectric layer 446 to the ground plane structure 462. The dielectric layer 446 at least partially surrounds the via openings 466, isolating them from one another and from other openings that may be formed (not shown in FIG. 4D) both physically and electrically.

In various embodiments, largest dimensions of the vias 466 could be between 5 and 1000 nm for both the x-axis and y-axis, including all values and ranges therein.

In various embodiments, any kind of etching techniques, possibly techniques that involve etching in combination with patterning, e.g. patterning as described above, may be used to form the vias 466. For example, once patterning has been done to expose portions of the underlying layer 446 in a patterned mask that defines location and arrangement of future vias 466, exposed portions of the underlying layer 446 are then chemically etched. During the etch, the exposed portions of the surface of the dielectric layer 446 are removed until a desired depth is achieved, forming via openings 466 in the dielectric layer 446. If photoresist patterning is used for creating a mask for forming vias, the remaining photoresist may then optionally removed via e.g. a process such as aching, where the photoresist is exposed to oxygen or fluorine, which combines with the photoresist to form ash.

The method 500 may then proceed with filling the one or more vias 466 in the dielectric layer 446 with a conducting or superconducting material 448 suitable to provide electrical connectivity to the ground plane 462 (process 510 of FIG. 5A, result of which is illustrated with a structure 410 of FIG. 4E). In various embodiments, the via material 448 may comprise any conducting or superconducting material suitable for serving as an interconnect in a quantum circuit, such as e.g. materials described above with reference to the material of the ground plane layer 444. In some embodiments, the via material 448 may be the same as the material of the ground plane layer 444. In other embodiments, at least some of the conductive or superconductive materials used in different elements described herein could be different.

The vias 466 could be filled with the via material 448 using any known techniques for filling via openings, such as e.g. CVD or PVD. Planarization, using e.g. any planarization processes described above, may also be performed in order to expose the surfaces 468 of the dielectric layer 446 which may be covered with the via material 448 as a result of depositing that material into the via openings.

In some embodiments, one or more of diffusion and adhesion barrier layers as known in the art may be deposited into the via openings 466 prior to filling the openings with the via material 448. As is known, diffusion barriers may serve to reduce diffusion of the conductive/superconductive via material out of the via and adhesion barriers may serve to promote adhesion between the conductive/superconductive via material and the walls of the via openings.

Next, optionally, an etch stop layer 450 may be formed over the surface of the dielectric material 446 and the vias 466 (process 512 of FIG. 5B, result of which is illustrated with a structure 412 of FIG. 4F). The etch stop layer is optional in that, in some embodiments, in particular when the transmission line fabricated is a microstrip line, it may be omitted altogether and the method 500 may proceed from the process of box 510 to the process of box 514. Some considerations as to when the etch stop layer could be included or omitted are described in greater detail below.

The etch stop material 450 could be selected as any material suitable for reducing or minimizing subsequent etching processes described herein. Examples of materials that may be used as the material of the etch stop layer 450 include, but are not limited to silicon nitride, silicon carbide, or other suitable materials.

In various embodiments, the etch stop layer 450 may be deposited using any suitable technique, such as e.g. CVD, plasma-enhanced CVD (PECVD), ALD, or plasma-enhanced ALD (PEALD). A thickness of the etch stop layer 450 could be between e.g. 20 and 100 nm, including all values and ranges therein.

In some embodiments, the surface of the dielectric material 446 may be cleaned or treated prior to applying the etch stop layer 450 to reduce surface contamination and minimize interface traps and/or promote adhesion, for example using a chemical or plasma clean, or applying heat in a controlled environment. In some embodiments, an “interface layer” may be applied between the dielectric material 446 and the etch stop layer 450 to prevent, decrease, or minimize spontaneous and uncontrolled formation of other interfacial layers. In some embodiments, an adhesion promoter or adhesion layer may be applied prior to application of the etch stop layer 450.

Again, in some embodiments, planarization of the etch stop layer 450 may be performed, e.g. using a process as described above.

Next, a layer of conductor strip material 452 is provided on either the etch stop layer 450, if such a layer is used, or on the surface 468 of the dielectric material 446 with the vias 466, if the etch stop layer 450 is not used (process 514 of FIG. 5B, result of which is illustrated with a structure 414 of FIG. 4G). Considerations described above with reference to the ground plane material 444 are applicable to the conductor strip material 452 and deposition thereof and, therefore, in the interest of brevity, are not repeated here. In some embodiments, the conductor strip material 452 may be the same as the material of the ground plane layer 444 or/and as the material 448 of the vias 466 in the dielectric layer 446.

In some embodiments, the surface of the dielectric material 446 or the etch stop layer 450 may be cleaned or treated prior to applying the conductor strip material 452 to reduce surface contamination and minimize interface traps and/or promote adhesion, for example using a chemical or plasma clean, or applying heat in a controlled environment. In some embodiments, an adhesion promoter or adhesion layer may be applied prior to application of the conductor strip material 452.

In various embodiments, the thickness of the layer of the conductor strip material 452 may be between 20 and 500 nm including all values and ranges therein, e.g. between 20 and 300 nm, or between 20 and 200 nm.

The method 500 may then proceed with patterning the layer of the conductor strip material 452 to form a structure that will serve as a conductor strip of a transmission line for one or more qubits (process 516 of FIG. 5B, result of which is illustrated with a structure 416 of FIG. 4H). An example of such structure is shown as a substantially straight line 470 shown in FIG. 4H. However, in other embodiments, the conductor strip structure 470 could have any other shapes/geometries suitable for serving as a signal line conductor of a microstrip line or a stripline, all of which shapes/geometries being within the scope of the present disclosure. For example, the conductor strip 470 may have various shapes such as e.g. substantially straight line, a lines with bends (e.g. a wiggly line or a line comprising one or more loop portions), or any other configuration suitable for a particular quantum circuit design.

In various embodiments, the width of the conductor strip 470 may be between 0.05 and 20 micron including all values and ranges therein, e.g. between 1 and 11 micron, or between 3 and 5 micron.

The length of a resonator, and, hence, the length of the conductor strip 470, is primarily set by the desired resonant frequency. In some embodiments, target frequencies may be between 2 and 10 GHz, e.g. between 3 and 7 GHz. The resonant frequency of a microwave resonator inversely depends on the length of the resonator, where, with everything else equal, a longer resonator will resonate at longer wavelengths and, therefore, lower frequencies. Resonators can also be designed to be at same length as the resonant wavelength, to be half the wavelength, or to be a quarter of the wavelength. The resonant frequency, and therefore the length of the center conductor, is also affected by the capacitance and inductance of the resonator, including the kinetic inductance of the superconducting wire. On the upper end, the longest microwave transmission line could be limited, roughly, by the length of the chip, although the length could exceed the chip length if the transmission line has curves/wiggles. A microwave feedline could be towards the upper end in length. In various embodiments, the length of the conductor strip 470 may be between 60 microns and 33 millimeters (mm), including all values and ranges therein, e.g. between 5 mm and 20 mm, or between 6 mm and 15 mm.

In various embodiments, any kind of conventional patterning techniques may be used to form the conductor strip 470. Descriptions provided above with reference to patterning the ground plane 462 are applicable to patterning the conductor strip 470 and, therefore, in the interests of brevity, are not repeated here.

At this point, if the desired transmission line is a microstrip line (i.e. a transmission line with a single ground plane and a conductor strip), the fabrication of the transmission line may be considered finished. The ground plane 462 and the conductor strip 470 need to be electrically connected to the ground potential and signal source as known in the art, which steps, therefore not described here. Optionally, the structure 416 may then be encapsulated in order to be protected from the negative effects of the environment when such a structure is to be deployed and electrical connections could be made. This could be done in a manner similar to e.g. that described in processes 530-534 for the stripline example.

In case the desired transmission line is a microstrip line, providing the ground plane 462 below the signal line 470 allows concentrating/containing electromagnetic fields within the bulk of the dielectric layer 446 because the electromagnetic fields will extend between the signal line and the ground plane. This means that less of the electromagnetic field will be concentrated at the superconductor-air interfaces, which are believed to be lossy in terms of spurious TLS's. Furthermore, containing the electromagnetic fields by adding a ground plane may help reduce cross-talk, i.e. interference, between different conducting strips in the vicinity of one another, in particular when wires run above and below each other. Additionally, at least the superconductor/conductor of the ground plane 462 is completely encapsulated, i.e. hermetically sealed and protected from the effects of the environment, which may also reduce losses and improve on the decoherence and aging problems of qubits.

If the desired transmission line is a stripline (i.e. a transmission line with a conductor strip sandwiched between two ground planes), the method 500 may proceed to process 518 where a layer of insulating material 454 is provided over substrate 442 with the conductor strip 470 formed thereon (process 518 of FIG. 5B, result of which is illustrated with a structure 418 of FIG. 4I).

In case the desired transmission line is a stripline, the ground plane material 444, the ground plane 462, the dielectric 446, and the vias 466 within the dielectric 446 may all be referred to with a descriptive indicator term “lower” before their respective names, in order to differentiate from similar elements above the conductor strip. On the other hand, the similar element above the conductor strip 470 may be referred to with a descriptive indicator term “upper” before their respective names. These elements are referred to as “lower” and “upper” in the illustration of the method 500 shown in FIGS. 5A-5D.

For the process 518, considerations described above with reference to the dielectric material 444 are applicable to the dielectric material 454 and deposition thereof and, therefore, in the interest of brevity, are not repeated here. In some embodiments, the dielectric material 454 may be the same as the dielectric material 444. In other embodiments, these materials may be different. Optionally, planarization may be performed in order to achieve a relatively smooth, plane surface of the dielectric layer 454. A thickness of the dielectric layer 454, e.g. as measured as a thickness 472 shown in FIG. 4I, could depend on e.g. the desired distance between the conductor strip and the upper ground plane of the future stripline. For example, the dielectric layer 454 may have a thickness between e.g. 20 and 3000 nm, including all values and ranges therein, typically for qubit applications between 50 and 100 nm.

The method 500 may then proceed with forming one or more first vias 474-1 in the dielectric layer 454 to connect to the conductor strip 470 and one or more second vias 474-2 in the dielectric layer 454 to connect to the ground plane 462 via the vias 466 (process 520 of FIG. 5C, result of which is illustrated with a structure 420 of FIG. 4J). In order to properly illustrate the different via openings 474, starting from FIG. 4J, two side views are shown in each figure. The upper side view AA in each of FIGS. 4J-4Q illustrates a cross-section along a line that goes through the one or more first via openings 474-1, such as e.g. a line AA shown in the top view of FIG. 4J. The lower side view BB in each of FIGS. 4J-4Q illustrates a cross-section along a line that goes through the one or more second via openings 474-2, such as e.g. a line BB shown in the top view of FIG. 4J. Thus, the upper side view in each of FIGS. 4J-4Q illustrates electrical connections to the conductor strip 470 configured to connect the conductor strip 470 to a signal source, while the lower side view illustrates electrical connections to the lower ground plane 462 configured to connect the lower ground plane 462 to the ground potential.

Number, dimensions and a shape of the first vias 474-1 could depend on e.g. the conductive/superconductive material used to fill the vias, dimensions and shape of the conductor strip 470, and the etching process used to form the first vias 474-1. For example, in some embodiments, a plurality of vias arranged along a line of the conductor strip 470 could be used, as shown in the top view in FIG. 4J. However, in other embodiments, any other number of first vias 474-1, arranged in any location and in any shape/geometry as suitable for providing electrical interconnection to the conductor strip 470 of a microstrip line or a stripline may be used, all of which being within the scope of the present disclosure.

The first via openings 474-1 extend from the surface of the dielectric layer 454 to the conductor strip 470. The dielectric layer 454 at least partially surrounds the first via openings 474-1, isolating them from one another and from other openings that may be formed in that layer, e.g. from the second via openings 474-2, both physically and electrically.

In various embodiments, largest dimensions of the first vias 474-1 could be between 5 and 40 nm for both the x-axis and y-axis, including all values and ranges therein.

In various embodiments, any kind of etching techniques, possibly techniques that involve etching in combination with patterning, e.g. patterning as described above, may be used to form the first and second vias 474. In some embodiments, both the first and second vias 474 are formed in a single etching step. For example, once patterning has been done to expose portions of the underlying layer 454 in a patterned mask that defines location and arrangement of future vias 474, exposed portions of the underlying layer 454 are then chemically etched, which could be done in a manner described above the lower vias 466.

If the etch stop layer 450 was used, then additional etching may be required to etch through the etch stop layer in order to extend the second vias 474-2 all the way down to the ground plane 462. This is illustrated with a process 522 of FIG. 5C, result of which is illustrated with a structure 422 of FIG. 4K. Alternatively, even if the etch stop layer 450 was used, etching of the second vias 474-2 all the way down to the lower ground plane 462 could be considered done in a single etching step (i.e. the illustration of FIG. 4J could be skipped and the final result shown directly with FIG. 4K, and processes 520 and 522 could be considered a single process).

Number, dimensions and a shape of the second vias 474-2 could depend on those of the lower vias 466 because the second vias 474-2 are intended to provide direct electrical connection to the lower vias 466 in order to connect the lower ground plane 462 to ground potential. Preferably, the number, dimensions and a shape of the second vias 474-2 could match the number, dimensions and a shape of the lower vias 4466 so that the vias could overlap, as shown with the illustration of FIGS. 4J and 4K.

The second via openings 474-2 extend from the surface of the dielectric layer 454 to the lower vias 466 which reach to the lower ground plane 462. The dielectric layer 454 at least partially surrounds the second via openings 474-2, isolating them from one another and from other openings that may be formed in that layer, e.g. from the first via openings 474-1, both physically and electrically.

The method 500 may then proceed with filling the one or more first vias 474-1 and one or more second vias 474-2 in the dielectric layer 454 with a conducting or superconducting material 456 suitable to provide electrical connectivity to, respectively, the conductor strip 470 and the ground plane 462 (process 524 of FIG. 5C, result of which is illustrated with a structure 424 of FIG. 4L). Considerations provided above for filling the lower vias 466 are applicable to the upper vias 474 and, therefore, in the interests of brevity, the descriptions are not repeated.

In various embodiments, the via material 456 may be the same as the material of the lower ground plane layer 444, of the lower vias 466, or of the conductor strip 470.

Planarization, using e.g. any planarization processes described above, may also be performed in order to expose the surfaces 476 of the dielectric layer 454 which may be covered with the via material 456 as a result of depositing that material into the via openings 474.

The method 500 may then proceed with depositing a layer of upper ground plane material 457 provided over the surface 476 with the first and second vias 474 (process 526 of FIG. 5C, result of which is illustrated with a structure 426 of FIG. 4M). The upper ground plane material 457 is then patterned to form the upper ground plane structure 480 (process 528 of FIG. 5D, result of which is illustrated with a structure 428 of FIG. 4N). Descriptions provided above with respect to depositing and patterning the lower ground plane are applicable to the upper ground plane and, therefore, in the interests of brevity, are not repeated here. In addition to patterning the upper ground plane 480, the process 528 could also be used to extend an electrical interconnect from the first vias 474-1, as shown in the side view AA with a structure 478.

At this point, the fabrication of the stripline may be considered finished. The ground planes 462 and 480 need to be electrically connected to the ground potential, and the conductor strip 470—to the signal source as known in the art, which steps, therefore not described here.

Providing the ground planes 462 and 480 below and above the signal line 470 allows concentrating electromagnetic fields within the bulk of the dielectric layers 446 and 454, respectively, because the electromagnetic fields will extend between the signal line and the respective ground plane. This means that, for the stripline architecture, less of the electromagnetic field will be concentrated at the superconductor-air interfaces, which are believed to be lossy in terms of spurious TLS's. Additionally, at least the superconductor/conductor of the lower ground plane 462 and the superconductor/conductor of the conductor strip 470 are completely encapsulated, i.e. hermetically sealed and protected from the effects of the environment, which may also reduce losses and improve on the decoherence and aging problems of qubits.

Optionally, the stripline structure 428 may then be encapsulated in order to be protected from the negative effects of the environment when such a structure is to be deployed and electrical connections could be made. This is shown with processes 530-534 of the method 500.

In the process 530 of FIG. 5D, result of which is illustrated with a structure 430 of FIG. 4O, a layer of insulating material 458, referred to herein as an “inter layer dielectric” (ILD) is provided over structure 428 with the upper ground plane 480 formed thereon.

For the process 530, considerations described above with reference to the dielectric materials 444 and 454 are applicable to the dielectric material 458 and deposition thereof and, therefore, in the interest of brevity, are not repeated here. In some embodiments, the dielectric material 458 may be the same as the dielectric material 444 and/or the dielectric material 454. In other embodiments, these materials may be different. Optionally, planarization may be performed in order to achieve a relatively smooth, plane surface of the dielectric layer 458. A thickness of the dielectric layer 458, e.g. measured as a thickness 482 shown in FIG. 4O, could depend on e.g. the desired distance to the surface of the device from the upper ground plane 480 of the stripline. For example, the dielectric layer 458 may have a thickness between e.g. 20 and 3000 nm, including all values and ranges therein, typically for qubit applications between 50 and 100 nm.

The method 500 may then proceed with forming one or more first vias 484-1 in the ILD 458 to connect to the conductor strip 470 and one or more second vias 484-2 to connect to the upper ground plane 480 (process 532 of FIG. 5D, result of which is illustrated with a structure 432 of FIG. 4P).

Number, dimensions and a shape of the second vias 484-2 could depend on e.g. the conductive/superconductive material used to fill the vias, dimensions and shape of the upper ground plane 480, and the etching process used to form the second vias 484-2. For example, in some embodiments, a single via could be used, as shown in the top view in FIG. 4P. However, in other embodiments, any other number of second vias 484-2, arranged in any location and in any shape/geometry as suitable for providing electrical interconnection to the upper ground plane 480 of a stripline may be used, all of which being within the scope of the present disclosure. The second vias 484-2 extend from the surface of the dielectric layer 458 to the upper ground plane 480. The dielectric layer 458 at least partially surrounds the second via openings 484-2, isolating them from one another and from other openings that may be formed in that layer, e.g. from the first via openings 484-1, both physically and electrically.

In various embodiments, largest dimensions of the second vias 484-2 could be between 5 and 40 nm for both the x-axis and y-axis, including all values and ranges therein.

In various embodiments, any kind of etching techniques, possibly techniques that involve etching in combination with patterning, e.g. patterning as described above, may be used to form the first and second vias 484. In some embodiments, both the first and second vias 484 are formed in a single etching step. For example, once patterning has been done to expose portions of the underlying layer 458 in a patterned mask that defines location and arrangement of future vias 484, exposed portions of the underlying layer 458 are then chemically etched, which could be done in a manner described above the lower vias 466.

Number, dimensions and a shape of the first vias 484-1 could depend on those of the first vias 474-1 because the first vias 484-1 are intended to provide direct electrical connection to the first vias 474-1 in order to connect the conductor strip 470 to signal source. Preferably, the number, dimensions and a shape of the first ILD vias 484-1 could match the number, dimensions and a shape of the first upper vias 474-1 so that the vias could overlap, as shown with the illustration of FIGS. 4P and 4Q.

The first via openings 484-1 extend from the surface of the dielectric layer 458 to the first vias 474-1 which reach to the conductor strip 470. The dielectric layer 458 at least partially surrounds the first vias 484-1, isolating them from one another and from other openings that may be formed in that layer, e.g. from the second via openings 484-2, both physically and electrically.

The method 500 may then proceed with filling the one or more first vias 484-1 and one or more second vias 484-2 in the dielectric layer 458 with a conducting or superconducting material 460 suitable to provide electrical connectivity to, respectively, the conductor strip 470 and the ground planes 480 and 462 (process 534 of FIG. 5D, result of which is illustrated with a structure 434 of FIG. 4Q). Considerations provided above for filling the first and second upper vias 474 are applicable to the ILD vias 484 and, therefore, in the interests of brevity, the descriptions are not repeated.

In various embodiments, the via material 460 may be the same as the material of the lower ground plane layer 444, of the lower vias 466, of the conductor strip 470, or of the upper ground plane layer 457.

Planarization, using e.g. any planarization processes described above, may also be performed in order to expose the surfaces 486 of the dielectric layer 458 which may be covered with the via material 460 as a result of depositing that material into the via openings 484.

It should be noted that while FIGS. 4A-4Q illustrate an example with only one signal line 470 formed within a transmission line structure, explanations provided herein could easily be extended to embodiments where multiple such signal lines are formed, all of which are within the scope of the present disclosure.

Furthermore, while FIGS. 4A-4Q illustrate connecting the lower and the upper ground planes to a single ground potential, in other embodiments these ground planes could be connected to individual reference potentials.

Microstrip line and stripline types of transmission line structures as described herein could be particularly useful as a quantum circuit resonator 104 coupled to the one or more of the plurality of qubits 102, shown in FIG. 1. In various embodiments, such a resonator could be coupled to the one or more qubits 102 via capacitive or inductive coupling. The resonator could be a coupling resonator or a readout resonator. If the resonator is a coupling resonator, then it could be coupled to two or more qubits, thereby coupling two or more qubits so that a change of state of one qubit may cause a change of state of the other qubits. If the resonator is a readout resonator, then typically each qubit could have its own readout resonator (i.e. a given readout resonator would be coupled to only one qubit) so that a state of each qubit could be determined independently from other qubits.

A plurality of qubits could be advantageously provided within the same plane as the conductor strip 470 of either the microstrip or the stripline architectures described herein. Any of the known methods could be used for providing the qubits, all of which being within the scope of the present disclosure. Providing the qubits in the plane of the conductor strip 470 may be particularly advantageous for the stripline architecture in that the qubits could then be encapsulated (i.e. hermetically sealed) by the upper dielectric 454 on top and by the lower dielectric 446 on the bottom, eliminating interfaces of the superconductive materials which may be used in the qubits with air.

In case of the microstrip lines, the qubits could be provided on the upper surface of the structure 416. In such a case, at least some of the processes of forming the conductor strip 470 could also be used to fabricate at least parts of the qubits (i.e. qubits and parts of the microstrip line could be fabricated in some shared process steps).

In case of the striplines, the qubits could be provided on the upper surface of the structure 428. In such a case, at least some of the processes of forming the upper plane 480 could also be used to fabricate at least parts of the qubits (i.e. qubits and parts of the stripline could be fabricated in some shared process steps).

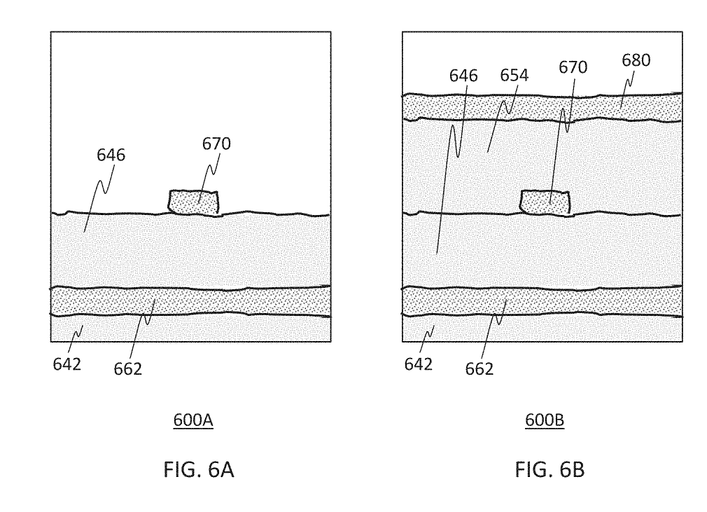

FIGS. 6A and 6B provide schematic illustrations of cross-sections of, respectively, a microstrip line structure 600A and a stripline structure 600B, according to some embodiments of the present disclosure. As can be seen, FIGS. 6A and 6B are drawn to reflect example real world process limitations, in that the features are not drawn with precise right angles and straight lines. Each of FIGS. 6A and 6B illustrates a substrate 642, a lower ground plane 662, a lower dielectric 646, and the signal line 470, as could be visible in e.g. a scanning electron microscopy (SEM) image or a transmission electron microscope (TEM) images of such structures. FIG. 6B further illustrates an upper dielectric 654 and an upper ground plane 680. Reference numerals 6XX used to indicate different elements of the structures 600A and 600B which are similar to reference numerals 4XX shown in FIGS. 4A-4Q are intended to represent similar elements—e.g. the ground plane 662 is similar to the ground plane 462, the conductor strip 670 is similar to the conductor strip 470, etc. Therefore, in the interests of brevity, descriptions of these elements are not repeated for FIGS. 6A and 6B.

Some Examples in accordance with various embodiments of the present disclosure are now described.

Example 1 provides a quantum integrated circuit assembly (which may also be referred to as an apparatus) including a substrate (442); a plurality of qubits disposed over the substrate; and a transmission line structure for one or more of the plurality of qubits, the transmission line structure including a ground plane structure (462) disposed over the substrate, a dielectric layer (446) disposed over the ground plane structure, and a conductor strip structure (470) disposed over the dielectric layer.

Example 2 provides the quantum integrated circuit assembly according to Example 1, where each of the ground plane structure and the conductor strip structure includes one or more of superconductive materials.

Example 3 provides the quantum integrated circuit assembly according to Example 2, where the one or more of superconductive materials includes one or more of aluminum (Al), niobium (Nb), niobium nitride (NbN), titanium nitride (TiN), or niobium titanium nitride (NbTiN).

Example 4 provides the quantum integrated circuit assembly according to any one of the preceding Examples, where a thickness of the ground plane structure is between 20 and 500 nm.

Example 5 provides the quantum integrated circuit assembly according to any one of the preceding Examples, where a thickness of the conductor strip structure is between 20 and 500 nm.

Example 6 provides the quantum integrated circuit assembly according to any one of the preceding Examples, where a thickness of the dielectric layer is between 20 and 3000 nm.

Example 7 provides the quantum integrated circuit assembly according to any one of the preceding Examples, further including one or more first interconnects (e.g. first upper vias 474-1) for connecting the conductor strip structure to a signal source and one or more second interconnects (e.g. second upper vias 474-2) for connecting the ground plane structure to a ground potential.

Example 8 provides the quantum integrated circuit assembly according to any one of the preceding Examples, where the ground plane structure is a lower ground plane structure, the dielectric layer is a lower dielectric layer, and the transmission line structure further includes an upper dielectric layer (454) disposed over the conductor strip structure, and an upper ground plane structure (480) disposed over the upper dielectric layer.

Example 9 provides the quantum integrated circuit assembly according to Example 8, where the upper ground plane structure includes one or more of superconductive materials.

Example 10 provides the quantum integrated circuit assembly according to Example 9, where the one or more of superconductive materials includes one or more of aluminum (Al), niobium (Nb), niobium nitride (NbN), titanium nitride (TiN), or niobium titanium nitride (NbTiN).

Example 11 provides the quantum integrated circuit assembly according to any one of Examples 8-10, where a thickness of the upper ground plane structure is between 20 and 500 nm.

Example 12 provides the quantum integrated circuit assembly according to any one of Examples 8-11, where a thickness of the upper dielectric layer is between 20 and 3000 nm.

Example 13 provides the quantum integrated circuit assembly according to any one of the preceding Examples, where at least parts of the plurality of qubits are disposed over the substrate in a single layer with the conductor strip structure.

Example 14 provides the quantum integrated circuit assembly according to Example 13, where the plurality of qubits are superconductive qubits and the at least parts of the plurality of qubits include capacitors of the superconductive qubits.

Example 15 provides the quantum integrated circuit assembly according to Example 14, where the capacitors include interdigitated capacitors.

Example 16 provides the quantum integrated circuit assembly according to Examples 14 or 15, where one or more flux control lines for the plurality of qubits are disposed in the single layer with the conductor strip structure.

Example 17 provides the quantum integrated circuit assembly according to any one of the preceding Examples, where the transmission line structure is a quantum circuit resonator coupled to the one or more of the plurality of qubits.

Example 18 provides the quantum integrated circuit assembly according to any one of the preceding Examples, further including a cooling apparatus for the plurality of qubits.

Example 19 provides a method for fabricating a quantum integrated circuit assembly, the method including providing a ground plane structure (462) over a substrate; providing a dielectric layer (446) over the ground plane structure; providing a conductor strip structure (470) over the dielectric layer; and providing a plurality of qubits in a single plane with the conductor strip structure, where the ground plane structure, the dielectric layer, and the conductor strip form a transmission line structure for one or more of the plurality of qubits.

Example 20 provides the method according to Example 19, further including providing one or more first interconnects (e.g. first upper vias 474-1) for connecting the conductor strip structure to a signal source; and one or more second interconnects (e.g. second upper vias 474-2) for connecting the ground plane structure to a ground potential.

Example 21 provides the method according to Example 19, where the ground plane structure is a lower ground plane structure, the dielectric layer is a lower dielectric layer, the method further including providing an upper dielectric layer (454) over the conductor strip structure; and providing an upper ground plane structure (480) over the upper dielectric layer.

Example 22 provides the method according to Example 21, further including providing one or more first interconnects (e.g. first upper vias 474-1 and first ILD vias 484-1) for connecting the conductor strip structure to a signal source; one or more second interconnects for connecting the lower ground plane structure to a first reference potential; and one or more third interconnects for connecting the upper ground plane structure to a second reference potential.

Example 23 provides the method according to Example 22, where the lower ground plane structure and the lower ground plane structure are connected to a single reference potential.

Example 24 provides the method according to any one of Examples 19-23, where providing the conductor strip structure includes providing a plurality of conductor strips.

Example 25 provides the method according to any one of Examples 19-24, further including encapsulating the quantum integrated circuit assembly.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

1. A quantum integrated circuit assembly comprising:
a substrate;
a plurality of qubits disposed over the substrate; and
a transmission line structure for one or more of the plurality of qubits, the transmission line structure comprising
a ground plane structure disposed over the substrate,
a dielectric layer disposed over the ground plane structure, and
a conductor strip structure disposed over the dielectric layer.

2. The quantum integrated circuit assembly according to claim 1, wherein each of the ground plane structure and the conductor strip structure comprises one or more of superconductive materials.

3. The quantum integrated circuit assembly according to claim 2, wherein the one or more of superconductive materials comprises one or more of aluminum (Al), niobium (Nb), niobium nitride (NbN), titanium nitride (TiN), or niobium titanium nitride (NbTiN).

4. The quantum integrated circuit assembly according claim 1, wherein a thickness of the ground plane structure is between 20 and 500 nanometers.

5. The quantum integrated circuit assembly according claim 1, wherein a thickness of the conductor strip structure is between 20 and 500 nanometers.

6. The quantum integrated circuit assembly according claim 1, wherein a thickness of the dielectric layer is between 20 and 3000 nanometers.

7. The quantum integrated circuit assembly according claim 1, further comprising one or more first interconnects for connecting the conductor strip structure to a signal source and one or more second interconnects for connecting the ground plane structure to a ground potential.

8. The quantum integrated circuit assembly according claim 1, wherein the ground plane structure is a lower ground plane structure, the dielectric layer is a lower dielectric layer, and the transmission line structure further comprises
an upper dielectric layer disposed over the conductor strip structure, and
an upper ground plane structure disposed over the upper dielectric layer.

9. (canceled)

10. (canceled)

11. The quantum integrated circuit assembly according to claim 8, wherein a thickness of the upper ground plane structure is between 20 and 500 nanometers.

12. The quantum integrated circuit assembly according to claim 8, wherein a thickness of the upper dielectric layer is between 20 and 3000 nanometers.

13. The quantum integrated circuit assembly according to claim 8, wherein at least parts of the plurality of qubits are disposed over the substrate in a single layer with the conductor strip structure.

14. The quantum integrated circuit assembly according to claim 13, wherein the plurality of qubits are superconductive qubits and the at least parts of the plurality of qubits comprise capacitors of the superconductive qubits.

15. The quantum integrated circuit assembly according to claim 14, wherein the capacitors comprise interdigitated capacitors.

16. The quantum integrated circuit assembly according to claim 14, wherein one or more flux control lines for the plurality of qubits are disposed in the single layer with the conductor strip structure.

17. The quantum integrated circuit assembly according claim 1, wherein the transmission line structure is a quantum circuit resonator coupled to the one or more of the plurality of qubits.

18. (canceled)

19. A method for fabricating a quantum integrated circuit assembly, the method comprising:
providing a ground plane structure over a substrate;
providing a dielectric layer over the ground plane structure;
providing a conductor strip structure over the dielectric layer; and
providing a plurality of qubits in a single plane with the conductor strip structure, wherein the ground plane structure, the dielectric layer, and the conductor strip form a transmission line structure for one or more of the plurality of qubits.

20. The method according to claim 19, further comprising:
providing one or more first interconnects for connecting the conductor strip structure to a signal source;
and one or more second interconnects for connecting the ground plane structure to a ground potential.

21. The method according to claim 19, wherein the ground plane structure is a lower ground plane structure, the dielectric layer is a lower dielectric layer, the method further comprising:
providing an upper dielectric layer over the conductor strip structure; and
providing an upper ground plane structure over the upper dielectric layer.

22. The method according to claim 21, further comprising:
providing one or more first interconnects for connecting the conductor strip structure to a signal source;
one or more second interconnects for connecting the lower ground plane structure to a first reference potential; and
one or more third interconnects for connecting the upper ground plane structure to a second reference potential.

23. The method according to claim 22, wherein the lower ground plane structure and the lower ground plane structure are connected to a single reference potential.

24. (canceled)

25. (canceled)
